(19) United States
(12) Patent Application Publication
(10) Pub. No.: US 2026/0179253 A1
(43) Pub. Date: Jun. 25, 2026

(54) POSITION DETERMINATION METHOD AND POSITION DETERMINATION APPARATUS

(71) Applicant: SCREEN Holdings Co., Ltd., Kyoto (JP)

(72) Inventors: Shinji SHIMIZU, Kyoto-shi, Kyoto (JP); Ryo YAMADA, Kyoto-shi, Kyoto (JP); Tatsuya MASUI, Kyoto-shi, Kyoto (JP); Yuichi DEBA, Kyoto-shi, Kyoto (JP); Miwa MIYAWAKI, Kyoto-shi, Kyoto (JP)

(21) Appl. No.: 19/121,421

(22) PCT Filed: Sep. 7, 2023
(86) PCT No.: PCT/JP2023/032642

§ 371 Date: Apr. 15, 2025

(30) Foreign Application Priority Data
Oct. 20, 2022 (JP) 2022-168104

(51) Int. Cl. G06T 7/73; G06T 7/00; G06T 7/33

(52) U.S. Cl. CPC G06T 7/74; G06T 7/001; G06T 7/337; G06T 2207/30121; G06T 2207/30148

(57) ABSTRACT

The technology disclosed in the present description relates to a technology for determining a position of a substrate with high accuracy. A position determination method includes: a step of setting a region including an end portion of a substrate in a reference image as a reference region and detecting a pixel position of the end portion of the substrate in the reference region as a reference pixel position; a step of setting a region including the end portion of the substrate in a comparison image as a comparison region and detecting a pixel position of the end portion of the substrate in the comparison region as a comparison pixel position; and a step of determining whether or not a difference between the reference pixel position and the comparison pixel position exceeds a predetermined threshold.

### TECHNICAL FIELD

The technology disclosed in the description of the present application relates to a substrate position determination technology. Examples of a processing target substrate include a semiconductor wafer, a glass substrate for a liquid crystal display apparatus, a substrate for a flat panel display (FPD) such as an organic electroluminescence (EL) display apparatus, a substrate for an optical disk, a substrate for a magnetic disk, a substrate for a magneto-optical disk, a glass substrate for a photomask, a ceramic substrate, a substrate for a field emission display (FED), a substrate for a solar cell, and the like.

### BACKGROUND ART

In the substrate processing, it is important that a processing target substrate is appropriately held.

For example, in Patent Document 1, a substrate is held by being adsorbed to a stage. In addition, in Patent Document 1, a positional deviation of the held substrate is detected on the basis of luminance information in an image obtained by an imaging unit.

### PRIOR ART DOCUMENT

### Patent Document

Patent Document 1: Japanese Patent Application Laid-Open No. 2007-251143

### SUMMARY

### Problem to be Solved by the Invention

However, in the method disclosed in Patent Document 1, the determination accuracy of the positional deviation of the substrate is not sufficient in some cases.

The technology disclosed in the present description has been made in view of the problem as described above, and is a technology for determining the positional deviation of the substrate with high accuracy.

### Means to Solve the Problem

A position determination method according to a first aspect of the technology disclosed in the present description includes: a step of capturing an image of a substrate that is held at a reference position of a substrate holding unit and is in a non-rotating state, and outputting the image captured as a reference image; a step of setting a region including an end portion of the substrate in the reference image as a reference region, and detecting a pixel position of the end portion of the substrate in the reference region as a reference pixel position; a step of capturing an image of the substrate that is disposed in the substrate holding unit and is in a non-rotating state, and outputting the image captured as a comparison image; a step of setting a region including the end portion of the substrate in the comparison image as a comparison region, and detecting a pixel position of the end portion of the substrate in the comparison region as a comparison pixel position; and a step of determining whether or not a difference between the reference pixel position and the comparison pixel position exceeds a predetermined threshold, in which the step of detecting the reference pixel position includes: a step of calculating a reference score that is a value obtained by integrating a difference between luminance of a target pixel that is a pixel to be a target in the reference region and luminance of an adjacent pixel that is a pixel adjacent to the target pixel in a radial direction of the substrate, between pixels aligned with the target pixel in a direction orthogonal to the radial direction; and a step of setting, as the reference pixel position, a position of the target pixel corresponding to the reference score that is highest among a plurality of the reference scores sequentially calculated in the radial direction in the reference region, and the step of detecting the comparison pixel position includes: a step of calculating a comparison score that is a value obtained by integrating a difference between luminance of a target pixel that is a pixel to be a target in the comparison region and luminance of an adjacent pixel that is a pixel adjacent to the target pixel in the radial direction of the substrate, between pixels aligned with the target pixel in a direction orthogonal to the radial direction; and a step of setting, as the comparison pixel position, a position of the target pixel corresponding to the comparison score that is highest among a plurality of the comparison scores sequentially calculated in the radial direction in the comparison region.

In a position determination method according to a second aspect of the technology disclosed in the present description and related to the position determination method according to the first aspect, the difference between the luminance of the target pixel and the luminance of the adjacent pixel is calculated only in a case where the luminance of one of the target pixel and the adjacent pixel located on an outer side in the radial direction of the substrate is higher than another of the target pixel and the adjacent pixel.

In a position determination method according to a third aspect of the technology disclosed in the present description and related to the position determination method according to the first or second aspect, the reference score is multiplied by a distribution coefficient based on a luminance distribution in the reference region to obtain a value that is to be set as a corrected reference score, and the reference pixel position is a position of the target pixel corresponding to the corrected reference score that is the highest in the reference region.

In a position determination method according to a fourth aspect of the technology disclosed in the present description and related to the position determination method according to the third aspect, the reference pixel position is the position of the target pixel corresponding to the corrected reference score that is the highest in the reference region only in a case where average luminance in a range on an inner side is lower than in a range on an outer side in the radial direction in the reference region.

In a position determination method according to a fifth aspect of the technology disclosed in the present description and related to the position determination method according to any one of the first to fourth aspects, the comparison score is multiplied by a distribution coefficient based on a luminance distribution in the comparison region to obtain a value that is to be set as a corrected comparison score, and the comparison pixel position is a position of the target pixel corresponding to the corrected comparison score that is the highest in the comparison region.

In a position determination method according to a sixth aspect of the technology disclosed in the present description and related to the position determination method according to the fifth aspect, the comparison pixel position is the position of the target pixel corresponding to the corrected comparison score that is the highest in the comparison region only in a case where average luminance in a range on an inner side is lower than in a range on an outer side in the radial direction in the comparison region.

In a position determination method according to a seventh aspect of the technology disclosed in the present description and related to the position determination method according to any one of the third to sixth aspects, the distribution coefficient is an average luminance of pixels located on the outer side in the radial direction than the target pixel.

In a position determination method according to an eighth aspect of the technology disclosed in the present description and related to the position determination method according to any one of the first to seventh aspects, the pixels in the reference region and the comparison region are mapped again to cause the pixels to be aligned 5 along the radial direction.

A position determination apparatus according to a ninth aspect of the technology disclosed in the present description includes: a substrate holding unit that holds a substrate; an imaging unit that captures an image of the substrate in the substrate holding unit; and an analysis unit that analyzes the image captured by the imaging unit and detects a pixel position of an end portion of the substrate, in which the imaging unit captures and sets an image of the substrate as a reference image, the substrate being held at a reference position of the substrate holding unit in the image and being in a non-rotating state, the reference image includes a reference region that is a region including an end portion of the substrate, the reference region having a pixel position of the end portion of the substrate set as a reference pixel position, the imaging unit captures and sets an image of the substrate as a comparison image, the substrate being disposed in the substrate holding unit and being in a non-rotating state, the comparison image includes a comparison region that is a region including an end portion of the substrate, the comparison region having a pixel position of the end portion of the substrate set as a comparison pixel position, the analysis unit detects the reference pixel position and the comparison pixel position and determines whether or not a difference between the reference pixel position and the comparison pixel position exceeds a threshold, and the analysis unit is configured to: calculate a reference score that is a value obtained by integrating a difference between luminance of a target pixel that is a pixel to be a target in the reference region and luminance of an adjacent pixel that is a pixel adjacent to the target pixel in a radial direction of the substrate, between pixels aligned with the target pixel in a direction orthogonal to the radial direction, and detects, as the reference pixel position, a position of the target pixel corresponding to the reference score that is highest among a plurality of the reference scores sequentially calculated in the radial direction in the reference region; and calculate a comparison score that is a value obtained by integrating a difference between luminance of a target pixel that is a pixel to be a target in the comparison region and luminance of an adjacent pixel that is a pixel adjacent to the target pixel in the radial direction of the substrate, between pixels aligned with the target pixel in a direction orthogonal to the radial direction, and detects, as the comparison pixel position, a position of the target pixel corresponding to the comparison score that is highest among a plurality of the comparison scores sequentially calculated in the radial direction in the comparison region.

### Effects of the Invention

According to at least the first and ninth aspects of the technology disclosed in the present description, the reference pixel position and the comparison pixel position can be detected with high accuracy by integrating the luminance difference in the direction orthogonal to the radial direction of the substrate. Therefore, the positional deviation of the substrate can be determined with high accuracy on the basis of the difference between the reference pixel position and the comparison pixel position.

Furthermore, objects, features, aspects, and advantages relating to the technology disclosed in the present description will be more apparent from the following detailed description and the accompanying drawings.

### BRIEF DESCRIPTION OF DRAWINGS

FIG. 1 is a plan view schematically illustrating an example of a configuration of a substrate processing apparatus related to an embodiment.

FIG. 2 is a plan view of a processing unit related to the embodiment.

FIG. 3 is a cross-sectional view of the processing unit related to the embodiment.

FIG. 4 is a diagram conceptually illustrating an example of functions of a control unit.

FIG. 5 is a diagram schematically exemplifying a hardware configuration in a case where the control unit illustrated in FIG. 4 as an example is actually operated.

FIG. 6 is a flowchart illustrating an operation of the substrate processing apparatus related to the embodiment.

FIG. 7 is a view illustrating an example of an image in a case where a spin chuck in a state of appropriately holding a substrate is imaged.

FIG. 8 is a schematic diagram of a reference region set in FIG. 7.

FIG. 9 is a schematic diagram of the reference region set in FIG. 7.

FIG. 10 is a schematic diagram of the reference region set in FIG. 7.

FIG. 11 is a diagram illustrating an example of distribution of reference scores in the reference region in a radial direction of a substrate.

FIG. 12 is a view illustrating an example of an image including the reference region.

FIG. 13 is a diagram illustrating an example of distribution of reference scores in the reference region in the radial direction of the substrate.

FIG. 14 is a view illustrating an example of an image including the reference region.

FIG. 15 is a flowchart illustrating an operation of the substrate processing apparatus related to the embodiment.

FIG. 16 is a diagram illustrating an example of an entire image of the entire spin chuck for obtaining the reference image in a first state.

FIG. 17 is a diagram illustrating a spin chuck, for obtaining a target image.

FIG. 18 is a diagram illustrating an example of a distribution of matching coordinates.

FIG. 19 is a diagram illustrating an example of a distribution of matching coordinates.

FIG. 20 is a diagram illustrating an example of extraction of a target image.

FIG. 21 is a diagram illustrating an example of reference coordinates in a reference image.

### DESCRIPTION OF EMBODIMENTS

Hereinafter, embodiments will be described with reference to the accompanying drawings. In the following embodiments, detailed features and the like are also shown for the description of the technology. However, these features are merely examples, and not all thereof are necessarily essential features in order to enable the embodiments to be carried out.

Note that the drawings are schematically illustrated, and omission of a configuration, simplification of a configuration, or the like is appropriately made in the drawings for convenience of description. In addition, the mutual relationship of sizes and positions of configurations and the like illustrated in different drawings is not necessarily accurately described, and can be appropriately changed. In addition, hatching is applied in some cases to a drawing such as a plan view that is not a cross-sectional view in order to facilitate understanding of the contents of the embodiment.

In addition, in the following description, similar constituent elements are denoted by the same reference signs, and names and functions thereof are also similar. Therefore, there is a case in which a detailed description thereof is omitted.

In addition, in the description described in the present application, in a case where a certain constituent element is described as “comprising”, “including”, “having”, or the like, the expression is not an exclusive expression excluding the presence of other constituent elements unless otherwise specified.

In addition, in the description described in the present application, even if ordinal numbers such as “first” or “second” are used, these terms are used for convenience to facilitate understanding of the contents of the embodiments, and the contents of the embodiments are not limited to the order or the like that can be caused by these ordinal numbers.

In addition, expressions indicating a relative or absolute positional relationship, for example, “in one direction”, “along one direction”, “parallel”, “orthogonal”, “center”, “concentric”, or “coaxial” in the description described in the present application include a case where the positional relationship is strictly indicated and a case where an angle or a distance is displaced within a range of a tolerance or in which a similar function is obtained, unless otherwise specified.

Furthermore, in the description described in the present application, even if terms meaning specific positions or directions such as “upper”, “lower”, “left”, “right”, “side”, “bottom”, “front”, or “back” are used, these terms are used for convenience to facilitate understanding of the contents of the embodiment, and are not related to the positions or directions at the time when the embodiment is actually implemented.

### First Embodiment

Hereinafter, a position determination apparatus and a position determination method of determining the position of the substrate to be processed in the substrate processing apparatus related to the present embodiment will be described.

### <Configuration of Substrate Processing Apparatus>

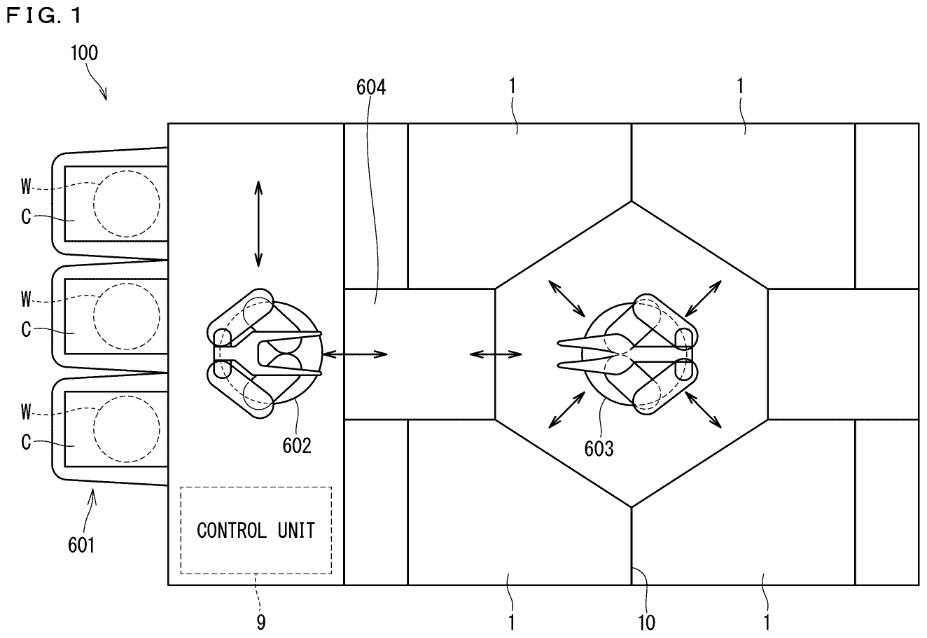

FIG. 1 is a plan view schematically showing an example of a configuration of a substrate processing apparatus 100 related to the present embodiment. The substrate processing apparatus 100 includes a load port 601, an indexer robot 602, a center robot 603, a control unit 9, and at least one processing unit 1 (four processing units in FIG. 1).

Note that examples of a processing target substrate include a semiconductor wafer, a glass substrate for a liquid crystal display apparatus, a substrate for a flat panel display (FPD) such as an organic electroluminescence (EL) display apparatus, a substrate for an optical disk, a substrate for a magnetic disk, a substrate for a magneto-optical disk, a glass substrate for a photomask, a ceramic substrate, a substrate for a field emission display (FED), a substrate for a solar cell, and the like.

The substrate processing apparatus 100 related to the present embodiment performs a cleaning treatment on a substrate W, which is a silicon substrate having a circular thin plate shape, by using a chemical liquid and a rinsing liquid such as pure water, and then performs a drying treatment.

As the chemical liquid, for example, a mixed solution of ammonia and a hydrogen peroxide solution (SC1), a mixed aqueous solution of hydrochloric acid and a hydrogen peroxide solution (SC2), or a dilute hydrofluoric acid (DHF) solution is used.

In the following description, the chemical liquid and the rinsing liquid are collectively referred to as “treatment liquid”. Note that not only for the cleaning treatment but also a coating liquid such as a photoresist liquid for film formation treatment, a chemical liquid for removing an unnecessary film, a chemical liquid for etching, and the like are included in the “treatment liquid”.

The processing unit 1 is a single wafer type apparatus that can be used for the substrate processing, and specifically, is an apparatus that performs processing of removing organic substances adhering to the substrate W. The organic substance attached to the substrate W is, for example, a used resist film. The resist film is used as, for example, an implantation mask for an ion implantation process.

Note that the processing unit 1 can include a chamber 10. In that case, by controlling the atmosphere in the chamber 10 by the control unit 9, the processing unit 1 can perform the substrate processing in a desired atmosphere.

The control unit 9 can control the operation of each configuration in the substrate processing apparatus 100. In addition, the control unit 9 can determine the position of the held substrate. A carrier C is a container that accommodates the substrate W. Furthermore, the load port 601 is a container holding mechanism that holds a plurality of the carriers C. The indexer robot 602 can transport the substrate W between the load port 601 and a substrate placing unit 604. The center robot 603 can convey the substrate W between the substrate placing unit 604 and the processing unit 1.

With the above configuration, the indexer robot 602, the substrate placing unit 604, and the center robot 603 function as a conveyance mechanism that conveys the substrate W between each of the processing units 1 and the load port 601.

The unprocessed substrate W is taken out from the carrier C by the indexer robot 602. Then, the unprocessed substrate W is delivered to the center robot 603 via the substrate placing unit 604.

The center robot 603 carries the unprocessed substrate W into the processing unit 1. Then, the processing unit 1 performs processing on the substrate W.

The substrates W processed in the processing unit 1 are taken out from the processing unit 1 by the center robot 603. Then, the processed substrate W is delivered to the indexer robot 602 via the substrate placing unit 604 after passing through another processing unit 1 as necessary. The indexer robot 602 carries the processed substrate W into the carrier C. As described above, the substrate W is processed.

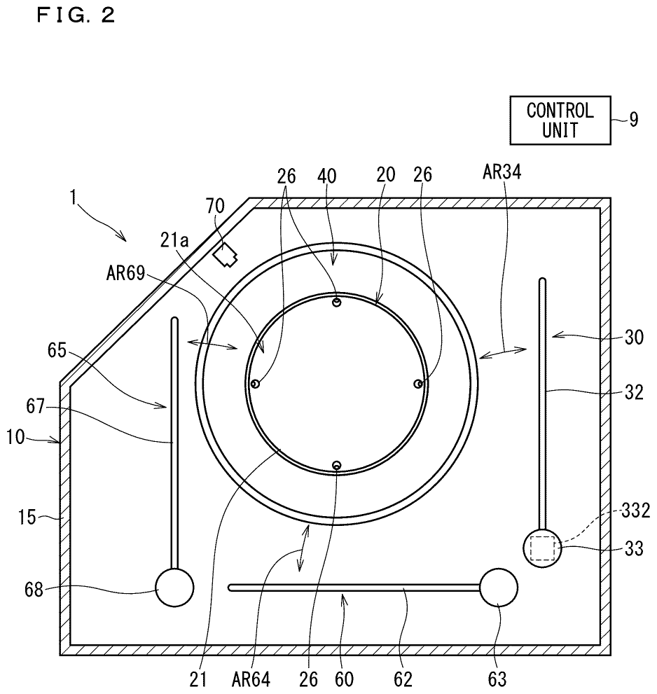

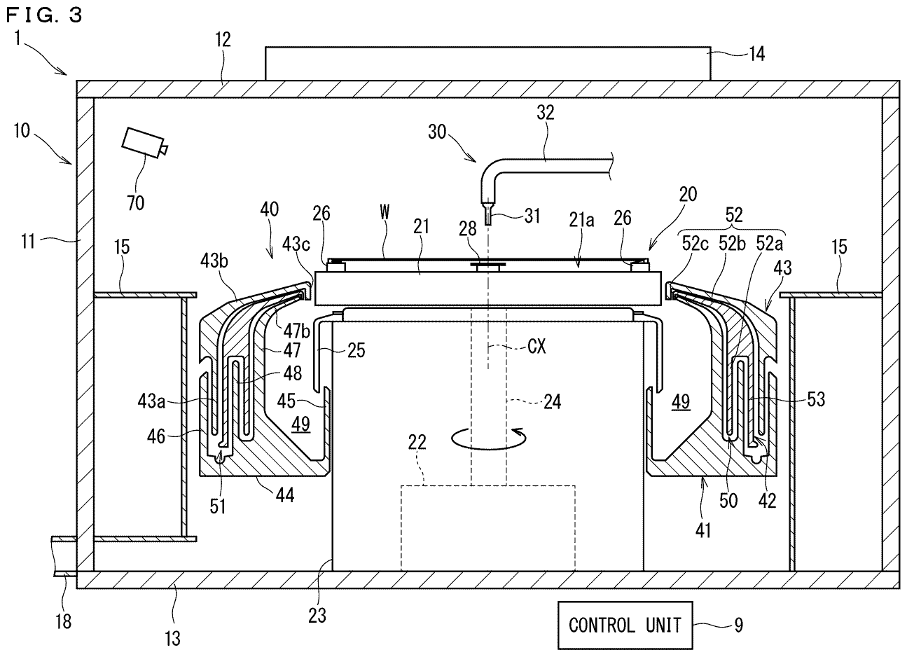

FIG. 2 is a plan view of the processing unit 1 related to the present embodiment. Furthermore, FIG. 3 is a cross-sectional view of the processing unit 1 related to the present embodiment.

FIG. 2 illustrates a state in which the substrate W is not held by a spin chuck 20, and FIG. 3 illustrates a state in which the substrate W is held by the spin chuck 20.

The processing unit 1 includes, in the chamber 10, the spin chuck 20 that holds the substrate W in a horizontal posture (that is, the normal line of the upper surface of the substrate W is in a posture along the vertical direction), three nozzles 30, 60, and 65 for supplying the treatment liquid to the upper surface of the substrate W held by the spin chuck 20, a processing cup 40 surrounding the periphery of the spin chuck 20, and a camera 70 that images the spin chuck 20 and the substrate W held by the spin chuck 20.

In addition, a partition plate 15 that vertically partitions the inner space of the chamber 10 is provided around the processing cup 40 in the chamber 10.

The chamber 10 includes a side wall 11 along the vertical direction and surrounding four sides, a ceiling wall 12 closing the upper side of the side wall 11, and a floor wall 13 closing the lower side of the side wall 11. A space surrounded by the side wall 11, the ceiling wall 12, and the floor wall 13 is a processing space of the substrate W.

In addition, a part of the side wall 11 of the chamber 10 is provided with a transfer port for the center robot 603 to carry the substrate W into and out of the chamber 10, and a shutter for opening and closing the transfer port (both not illustrated).

A fan filter unit (FFU) 14 for further cleaning the air in a clean room where the substrate processing apparatus 100 is installed and supplying the air to the processing space in the chamber 10 is attached to the ceiling wall 12 of the chamber 10. The FFU 14 includes a fan and a filter (for example, a high efficiency particulate air filter (HEPA) filter) for taking in the air in the clean room and sending the air into the chamber 10.

The FFU 14 creates downflow of the clean air in the processing space in the chamber 10. In order to uniformly disperse the clean air supplied from the FFU 14, a punching plate having a large number of blow-out holes may be provided immediately below the ceiling wall 12.

The spin chuck 20 includes a spin base 21, a spin motor 22, a cover member 23, and a rotating shaft 24. The spin base 21 has a disk shape and is fixed in a horizontal posture to the upper end of the rotating shaft 24 extending along the vertical direction. The spin motor 22 is provided below the spin base 21 and rotates the rotating shaft 24. The spin motor 22 rotates the spin base 21 in the horizontal plane via the rotating shaft 24. The cover member 23 has a tubular shape surrounding the spin motor 22 and the rotating shaft 24.

The outer diameter of the disk-shaped spin base 21 is slightly larger than the diameter of the circular substrate W held by the spin chuck 20. The spin base 21 has a holding surface 21a facing the entire lower surface of the substrate W to be held.

A plurality of (four in the present embodiment) chuck pins 26 are provided on a peripheral edge portion of the holding surface 21a of the spin base 21. The plurality of chuck pins 26 are disposed at equal intervals along the circumference corresponding to the outer diameter of the outer peripheral circle of the circular substrate W. In the present embodiment, four pieces of the chuck pins 26 are provided at 90° intervals.

The plurality of chuck pins 26 are driven in conjunction with each other by a link mechanism (not illustrated) accommodated in the spin base 21. The spin chuck 20 grips the substrate W by bringing each of the plurality of chuck pins 26 into contact with the outer peripheral end of the substrate W to hold the substrate W above the spin base 21 in a horizontal posture close to the holding surface 21a (see FIG. 3). In addition, the spin chuck 20 releases the gripping of the substrate W by separating each of the plurality of chuck pins 26 from the outer peripheral end of the substrate W.

At least one of the plurality of chuck pins 26 is configured to be holdable by the outer peripheral end of the substrate W by a magnet, a spring, or the like, and can maintain each of an open state of being separated from the outer peripheral end of the substrate W and a closed state of being in contact with the outer peripheral end of the substrate W. Note that the driving of the chuck pin 26 is controlled by the control unit 9.

Note that, in a case where only some of the plurality of chuck pins 26 are driven to grip the substrate W, the other chuck pins 26 may be support pins that support the lower surface of the substrate W.

The cover member 23 covering the spin motor 22 has the lower end fixed to the floor wall 13 of the chamber 10 and the upper end reaching immediately below the spin base 21. At an upper end portion of the cover member 23, a flange-shaped member 25 is provided which projects substantially horizontally outward from the cover member 23 and further bends and extends downward.

By the spin motor 22 rotating the rotating shaft 24 in a state where the spin chuck 20 is holding the substrate W by gripping by the plurality of chuck pins 26, the substrate W can be rotated about a rotation axis CX extending along the vertical direction passing through the center of the substrate W. Note that the driving of the spin motor 22 is controlled by the control unit 9.

The nozzle 30 is configured by attaching a discharge head 31 to the tip end of a nozzle arm 32. The base end side of the nozzle arm 32 is fixedly connected to a nozzle base 33. The nozzle base 33 is rotatable about an axis along the vertical direction by a motor 332 (nozzle moving unit) provided on the nozzle base 33.

As the nozzle base 33 rotates, the nozzle 30 moves in a circular arc shape along the horizontal direction between the position above the spin chuck 20 and the standby position on the outer side of the processing cup 40 as indicated by an arrow AR34 in FIG. 2. By the rotation of the nozzle base 33, the nozzle 30 swings above the holding surface 21a of the spin base 21.

The processing unit 1 of the present embodiment is further provided with the two nozzles 60 and 65 in addition to the nozzle 30 described above. The nozzle 60 and the nozzle 65 of the present embodiment have the same configuration as the nozzle 30 described above.

That is, the nozzle 60 is configured by attaching a discharge head to the tip end of a nozzle arm 62, and moves in a circular arc shape between a processing position above the spin chuck 20 and a standby position on the outer side of the processing cup 40 as indicated by an arrow AR64, by a nozzle base 63 connected to the base end side of the nozzle arm 62.

Similarly, the nozzle 65 is configured by attaching a discharge head to the tip end of a nozzle arm 67, and moves in a circular arc shape between a processing position above the spin chuck 20 and a standby position on the outer side of the processing cup 40 as indicated by an arrow AR69, by a nozzle base 68 connected to the base end side of the nozzle arm 67.

A plurality of types of treatment liquids containing at least pure water are also supplied to the nozzle 60 and the nozzle 65, and the treatment liquids are discharged to the upper surface of the substrate W held by the spin chuck 20 at the processing position.

A lower surface treatment liquid nozzle 28 is provided along the vertical direction in a manner that the nozzle is inserted through the inside of the rotating shaft 24. The upper end opening of the lower surface treatment liquid nozzle 28 is formed at a position facing the center of the lower surface of the substrate W held by the spin chuck 20. The plurality of types of treatment liquids are also supplied to the lower surface treatment liquid nozzle 28. The treatment liquid discharged from the lower surface treatment liquid nozzle 28 is deposited on the lower surface of the substrate W held by the spin chuck 20.

Note that the driving of the nozzle 30, the nozzle 60, the nozzle 65, and the lower surface treatment liquid nozzle 28 is controlled by the control unit 9.

The processing cup 40 surrounding the spin chuck 20 includes an inner cup 41, a middle cup 42, and an outer cup 43 that can be lifted and lowered independently of each other. The inner cup 41 surrounds the spin chuck 20 and has a shape that is substantially rotationally symmetric with respect to the rotation axis CX passing through the center of the substrate W held by the spin chuck 20. The inner cup 41 integrally includes a bottom portion 44 having an annular shape in plan view, a cylindrical inner wall portion 45 rising upward from an inner peripheral edge of the bottom portion 44, a cylindrical outer wall portion 46 rising upward from an outer peripheral edge of the bottom portion 44, a first guide portion 47 rising from between the inner wall portion 45 and the outer wall portion 46 and extending obliquely upward toward the center side (in a direction approaching the rotation axis CX of the substrate W held by the spin chuck 20) while drawing a smooth circular arc at an upper end portion, and a cylindrical middle wall portion 48 rising upward from between the first guide portion 47 and the outer wall portion 46.

The inner wall portion 45 is formed to have a length that allows the inner cup 41 to be accommodated while maintaining an appropriate gap between the cover member 23 and the flange-shaped member 25 in a state where the inner cup 41 is raised the most. The middle wall portion 48 is formed to have a length that allows the middle wall portion to be accommodated in a state where the inner cup 41 and the middle cup 42 are closest to each other while maintaining an appropriate gap between a second guide portion 52 and a treatment liquid separation wall 53 of the middle cup 42 which are described later.

The first guide portion 47 has an upper end portion 47b extending obliquely upward on the center side (direction approaching the rotation axis CX of the substrate W) while drawing a smooth circular arc. In addition, a disposal groove 49 for collecting and disposing of the used treatment liquid is formed between the inner wall portion 45 and the first guide portion 47. An annular inner recovery groove 50 for collecting and recovering the used treatment liquid is formed between the first guide portion 47 and the middle wall portion 48. Furthermore, an annular outer recovery groove 51 for collecting and recovering the treatment liquid different from the treatment liquid in the inner recovery groove 50 is formed between the middle wall portion 48 and the outer wall portion 46.

The middle cup 42 surrounds the spin chuck 20 and has a shape that is substantially rotationally symmetric with respect to the rotation axis CX passing through the center of the substrate W held by the spin chuck 20. The middle cup 42 includes the second guide portion 52 and the cylindrical treatment liquid separation wall 53 connected to the second guide portion 52.

The second guide portion 52 has, on the outer side the first guide portion 47 of the inner cup 41, a cylindrical lower end portion 52a that is coaxial with the lower end portion of the first guide portion 47, an upper end portion 52b that extends obliquely upward toward the center side (in a direction approaching the rotation axis CX of the substrate W) while drawing a smooth circular arc from the upper end of the lower end portion 52a, and a folded portion 52c formed by folding back the tip end portion of the upper end portion 52b downward. The lower end portion 52a is accommodated in the inner recovery groove 50 while maintaining an appropriate gap between the first guide portion 47 and the middle wall portion 48 in a state where the inner cup 41 and the middle cup 42 are closest to each other. Furthermore, the upper end portion 52b is provided so as to vertically overlap with the upper end portion 47b of the first guide portion 47 of the inner cup 41, and in a state where the inner cup 41 and the middle cup 42 are closest to each other, the upper end portion 52b is close to the upper end portion 47b of the first guide portion 47 with a very small interval. Regarding the folded portion 52c, the folded portion 52c horizontally overlaps with the tip end of the upper end portion 47b of the first guide portion 47 in a state where the inner cup 41 and the middle cup 42 are closest to each other.

The upper end portion 52b of the second guide portion 52 is formed to have a thickness increasing toward the lower side. The treatment liquid separation wall 53 has a cylindrical shape provided in a manner of extending downward from the lower end outer peripheral edge portion of the upper end portion 52b. The treatment liquid separation wall 53 is accommodated in the outer recovery groove 51 while maintaining an appropriate gap between the middle wall portion 48 and the outer cup 43 in a state where the inner cup 41 and the middle cup 42 are closest to each other.

The outer cup 43 has a shape that is substantially rotationally symmetric with respect to the rotation axis CX passing through the center of the substrate W held by the spin chuck 20. The outer cup 43 surrounds the spin chuck 20 on the outer side of the second guide portion 52 of the middle cup 42. This outer cup 43 functions as a third guide portion. The outer cup 43 has a lower end portion 43a coaxial with the lower end portion 52a of the second guide portion 52, an upper end portion 43b extending obliquely upward toward the center side (in a direction approaching the rotation axis CX of the substrate W) while drawing a smooth circular arc from the upper end of the lower end portion 43a, and a folded portion 43c formed by folding back the tip end portion of the upper end portion 43b downward.

The lower end portion 43a is accommodated in the outer recovery groove 51 while maintaining an appropriate gap between the treatment liquid separation wall 53 of the middle cup 42 and the outer wall portion 46 of the inner cup 41 in a state where the inner cup 41 and the outer cup 43 are closest to each other. The upper end portion 43b is provided so as to vertically overlap with the second guide portion 52 of the middle cup 42, and in a state where the middle cup 42 and the outer cup 43 are closest to each other, the upper end portion 43b is close to the upper end portion 52b of the second guide portion 52 with a very small interval. The folded portion 43c horizontally overlaps with the folded portion 52c of the second guide portion 52 in a state where the middle cup 42 and the outer cup 43 are closest to each other.

Note that the driving of the processing cup 40 is controlled by the control unit 9.

The partition plate 15 is provided so as to vertically partition the inner space of the chamber 10 around the processing cup 40.

The outer peripheral end of the partition plate 15 is connected to the side wall 11 of the chamber 10. Furthermore, an outer edge portion of the partition plate 15 surrounding the processing cup 40 is formed to have a circular shape having a diameter larger than the outer diameter of the outer cup 43.

In addition, an exhaust duct 18 is provided in a part of the side wall 11 of the chamber 10 and in the vicinity of the floor wall 13. The exhaust duct 18 is communicably connected to an exhaust mechanism (not illustrated). Among the clean air supplied from the FFU 14 and flowing down in the chamber 10, the air passing between the processing cup 40 and the partition plate 15 is discharged from the exhaust duct 18 to the outside of the apparatus.

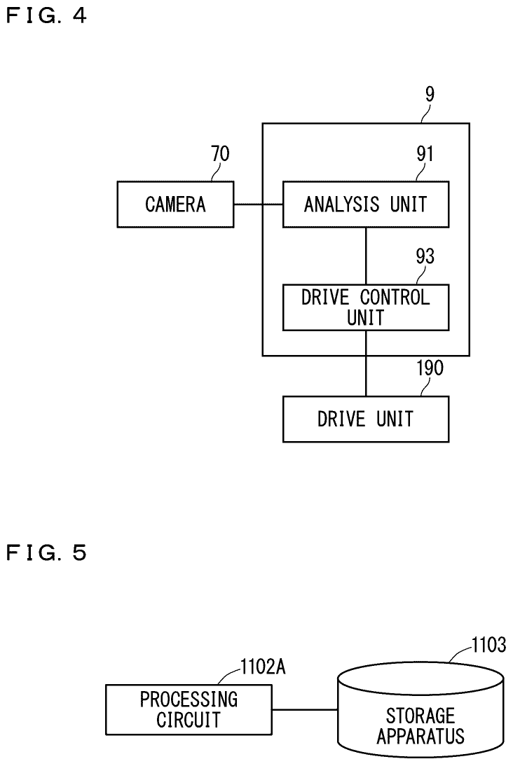

FIG. 4 is a diagram conceptually illustrating an example of functions of the control unit 9. As illustrated in FIG. 4 as an example, the control unit 9 includes an analysis unit 91 and a drive control unit 93. The control unit 9 also has a function as a position determination apparatus together with the spin chuck 20 that holds the substrate W and the camera 70 that images the substrate W in a held state.

The analysis unit 91 determines that the substrate W is appropriately held in the spin chuck 20. Note that a specific operation of the analysis unit 91 will be described later.

The drive control unit 93 controls the drive of the drive unit 190 including the chuck pin 26, the spin motor 22, the nozzle 30, the nozzle 60, the nozzle 65, the lower surface treatment liquid nozzle 28, and the processing cup 40 in the processing unit 1. Here, the drive unit 190 for the chuck pin 26 includes a motor (not illustrated) for moving a magnet or switching a state of a spring between biasing and unbiasing.

FIG. 5 is a diagram schematically exemplifying a hardware configuration in a case where the control unit 9 illustrated in FIG. 4 as an example is actually operated.

FIG. 5 illustrates a processing circuit 1102A that performs calculation and a storage apparatus 1103 that can store information, as hardware configurations for realizing the analysis unit 91 and the drive control unit 93 in FIG. 4.

The processing circuit 1102A is, for example, a central processing unit (CPU) or the like. The storage apparatus 1103 is, for example, a memory (storage medium) such as a hard disk drive (that is, HDD), a random access memory (RAM), a read only memory (ROM), or a flash memory.

### <Operation of Substrate Processing Apparatus>

The normal processing of the substrate W in the substrate processing apparatus 100 includes, in order, a process of carrying the substrate W to be processed received by the center robot 603 from the indexer robot 602 into each of the processing unit 1, a process of performing the substrate processing on the substrate W by the processing unit 1, and a process of carrying the processed substrate W out of the processing unit 1 and returning the substrate W to the indexer robot 602 by the center robot 603.

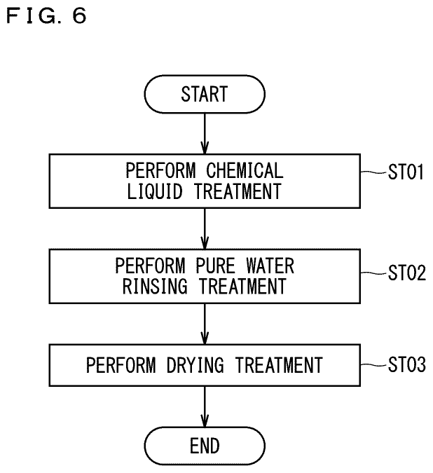

Next, with reference to FIG. 6, procedures of the cleaning treatment and the drying treatment among typical substrate processing of the substrates W in each processing unit 1 will be described. Note that FIG. 6 is a flowchart illustrating an operation of the substrate processing apparatus 100 related to the present embodiment. The following operation is mainly performed under the control of the control unit 9.

First, a chemical liquid is supplied to the surface of the substrate W to perform a predetermined chemical liquid treatment (step ST01). Thereafter, pure water is supplied to perform a pure water rinsing treatment (step ST02).

Further, the pure water is shaken off by rotating the substrate W at high speed to dry the substrate W (step ST03).

At the time of the processing unit 1 performing the substrate processing, the spin chuck 20 holds the substrate W, and the processing cup 40 performs a lifting and lowering operation.

In a case where the processing unit 1 performs the chemical liquid treatment, for example, only the outer cup 43 is lifted, and an opening surrounding the periphery of the substrate W held by the spin chuck 20 is formed between the upper end portion 43b of the outer cup 43 and the upper end portion 52b of the second guide portion 52 of the middle cup 42. In this state, the substrate W is rotated together with the spin chuck 20, and the chemical liquid is supplied from the nozzle 30 and the lower surface treatment liquid nozzle 28 to the upper surface and the lower surface of the substrate W. The supplied chemical liquid flows along the upper surface and the lower surface of the substrate W by the centrifugal force generated by the rotation of the substrate W, and is eventually scattered laterally from the outer edge portion of the substrate W. This advances the chemical liquid treatment of the substrate W. The chemical liquid scattered from the outer edge portion of the rotating substrate W is received by the upper end portion 43b of the outer cup 43, flows down along the inner surface of the outer cup 43, and is recovered in the outer recovery groove 51.

In a case where the processing unit 1 performs the pure water rinsing treatment, for example, all of the inner cup 41, the middle cup 42, and the outer cup 43 are lifted, and the periphery of the substrate W held by the spin chuck 20 is surrounded by the first guide portion 47 of the inner cup 41. In this state, the substrate W is rotated together with the spin chuck 20, and the pure water is supplied from the nozzle 30 and the lower surface treatment liquid nozzle 28 to the upper surface and the lower surface of the substrate W. The supplied pure water flows along the upper surface and the lower surface of the substrate W by the centrifugal force generated by the rotation of the substrate W, and is eventually scattered laterally from the outer edge portion of the substrate W. This advances the pure water rinsing treatment of the substrate W. The pure water scattered from the outer edge portion of the rotating substrate W flows down along the inner wall of the first guide portion 47 and is discharged from the disposal groove 49. Note that, in a case where the pure water is recovered in a path different from the chemical liquid, the middle cup 42 and the outer cup 43 may be lifted to form an opening surrounding the periphery of the substrate W held by the spin chuck 20 between the upper end portion 52b of the second guide portion 52 of the middle cup 42 and the upper end portion 47b of the first guide portion 47 of the inner cup 41.

In a case where the processing unit 1 performs the shaking off and drying treatment, all of the inner cup 41, the middle cup 42, and the outer cup 43 are lowered, and all of the upper end portion 47b of the first guide portion 47 of the inner cup 41, the upper end portion 52b of the second guide portion 52 of the middle cup 42, and the upper end portion 43b of the outer cup 43 are positioned below the substrate W held by the spin chuck 20. In this state, the substrate W is rotated at high speed together with the spin chuck 20, and water droplets adhered to the substrate W are shaken off by the centrifugal force, and the drying treatment is performed.

### <Determination of Holding Position of Substrate>

An operation of determining that the substrate W is appropriately held in the spin chuck 20 will be described below. The determination operation is performed by the control unit 9 prior to the substrate processing.

First, the analysis unit 91 of the control unit 9 sets a reference region and a comparison region in a plurality of images captured by the camera 70, further sets a pixel position corresponding to an end portion of the substrate W in the reference region as a reference pixel position, and sets a pixel position corresponding to an end portion of the substrate W in the comparison region as a comparison pixel position.

Then, in a case where the difference (difference in pixel positions) between the reference pixel position and the comparison pixel position does not exceed a predetermined threshold, the analysis unit 91 of the control unit 9 determines that the substrate W is appropriately held in the spin chuck 20. On the other hand, in a case where the difference between the reference pixel position and the comparison pixel position exceeds the predetermined threshold, the analysis unit 91 of the control unit 9 determines that the substrate W is not appropriately held, and performs predetermined warning (alarm display or the like).

### <Setting of Reference Region>

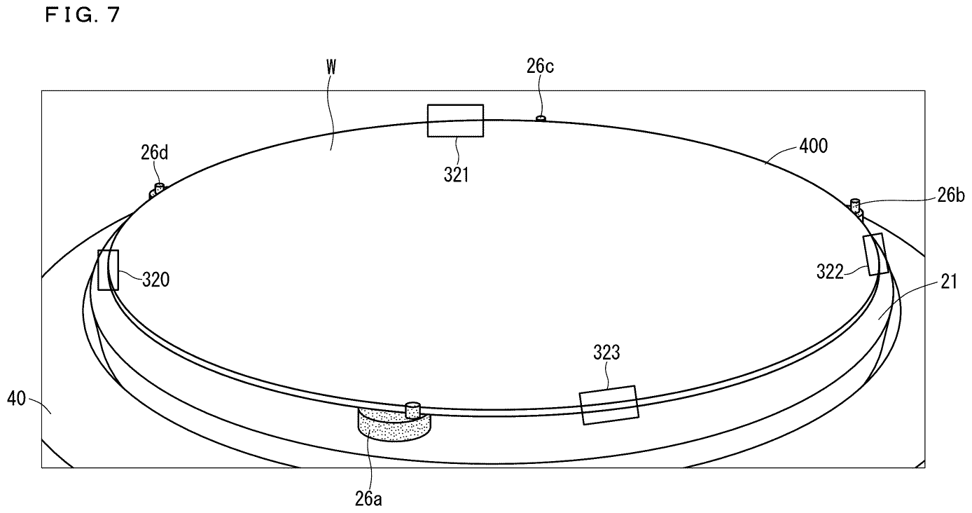

FIG. 7 is a view illustrating an example of an image in a case where the spin chuck 20 in a state of appropriately holding the substrate W is imaged by the camera 70. As illustrated in an example in FIG. 7, the substrate W is disposed at a reference position while facing the spin base 21 of the spin chuck 20, and has a peripheral edge portion thereof gripped by the plurality of chuck pins 26.

The analysis unit 91 in the control unit 9 sets a region including the end portion of the substrate W in the above image, that is a reference image that is an image indicating a state in which the non-rotating substrate W is held at the reference position, as a reference region 320, a reference region 321, a reference region 322, a reference region 323, and a reference region 304. Each of the reference regions is a region set at the end portion of the substrate W in an appropriately held state.

Here, the reference region is desirably set to a region having a relatively small luminance change among the region including the end portion of the substrate W. This is because, at the time when a luminance difference to be described later is calculated, a luminance change in a portion other than the end portion of the substrate W sometimes deteriorate the detection accuracy of the end portion of the substrate W. The luminance change of the portion other than the end portion of the substrate W is affected by, for example, the presence or absence of a structure disposed around the substrate W.

Next, the analysis unit 91 in the control unit 9 calculates the luminance of each pixel in the reference region, and further calculates a difference (luminance difference) in luminance between each pixel and an adjacent pixel. Here, the direction in which the pixels are adjacent to each other is a direction along the radial direction of the substrate W.

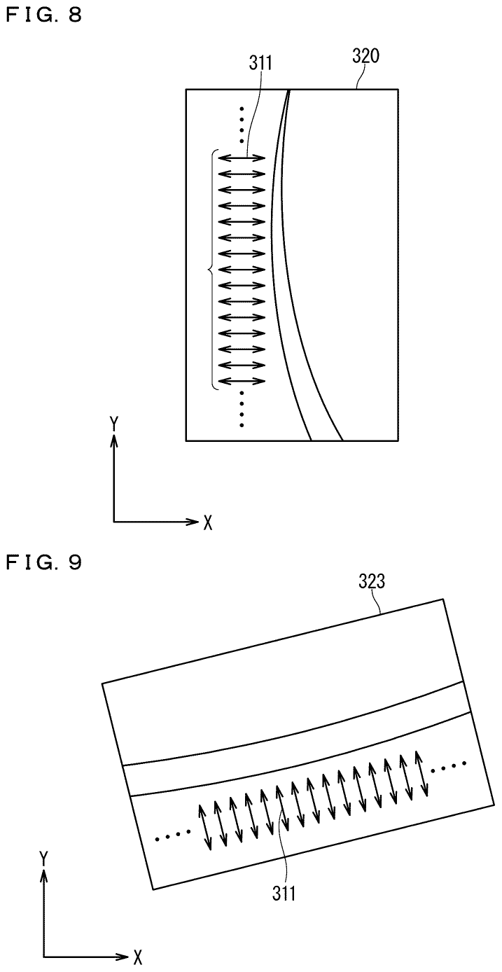

FIG. 8 is a schematic diagram of the reference region 320 set in FIG. 7. The X axis and the Y axis in FIG. 8 indicate directions in which the pixels are aligned. As illustrated in the example in FIG. 8, a direction 311 in which the pixels are adjacent to each other is a direction along the radial direction of the substrate W (corresponds to the X-axis direction in FIG. 8).

Here, the above luminance difference may be calculated only in a case where the luminance of the pixel located on the radially outer side of the substrate W (that is, the pixel located on the negative X-axis direction side in FIG. 8) is high, and may not be calculated (or set to 0) in a case where the luminance of the pixel located on the radially outer side of the substrate W is low. In this way, it is easy to distinguish between the image indicating the substrate W having the relatively low luminance and the image indicating the peripheral portion surrounding the substrate W having the relatively high luminance.

Then, the analysis unit 91 in the control unit 9 adds together the luminance differences calculated as described above for the respective pixels in the direction orthogonal to the radial direction of the substrate W (corresponds to the Y-axis direction in FIG. 8). By adding together the luminance differences in the direction orthogonal to the radial direction of the substrate W, the difference between the luminance difference of the pixel column in which the end portion of the substrate W is located and the luminance difference of other pixel columns becomes more remarkable, and thus, the detection accuracy of the end portion of the substrate W is improved. The value of the luminance differences thus added together in the reference region is set as a reference score.

Here, in the reference region set in an inclined manner in the image, such as the reference region 322 or the reference region 323 in FIG. 7, the radial direction of the substrate W does not coincide in some cases with the direction in which the pixels are adjacent to each other in the image. In such a case, the pixels may be mapped again to make the radial direction of the substrate W coincide with the direction in which the pixels are adjacent to each other. The mapping may be similarly performed again in the comparison region to be described later.

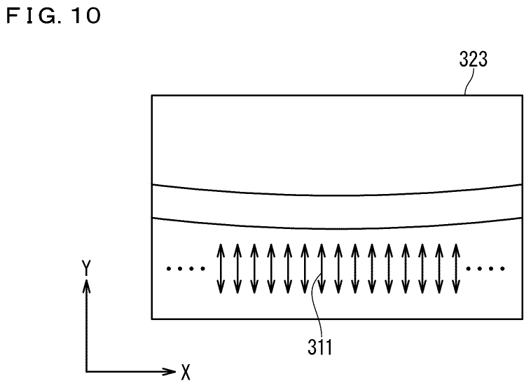

FIGS. 9 and 10 are schematic diagrams of the reference region 323 set in FIG. 7. The X axis and the Y axis in FIGS. 9 and 10 indicate directions in which pixels are aligned.

The direction (the X-axis direction and the Y-axis direction in FIG. 9) in which the pixels of the reference region 323 set in FIG. 7 are aligned does not coincide with the direction 311 in which the pixels are adjacent to each other. Therefore, the image corresponding to the reference region 323 is rotated to make the direction 311 coincide with the direction in which the pixels are aligned (the X-axis direction or the Y-axis direction in FIG. 9), and then the pixels are mapped again in the X-axis direction and the Y-axis direction. By changing the alignment of the pixels in the image in this manner, the luminance difference between adjacent pixels and the sum thereof can be easily calculated.

### <Detection of Reference Pixel Position>

Next, the analysis unit 91 in the control unit 9 compares the reference scores each calculated as described above in the radial direction of the substrate W.

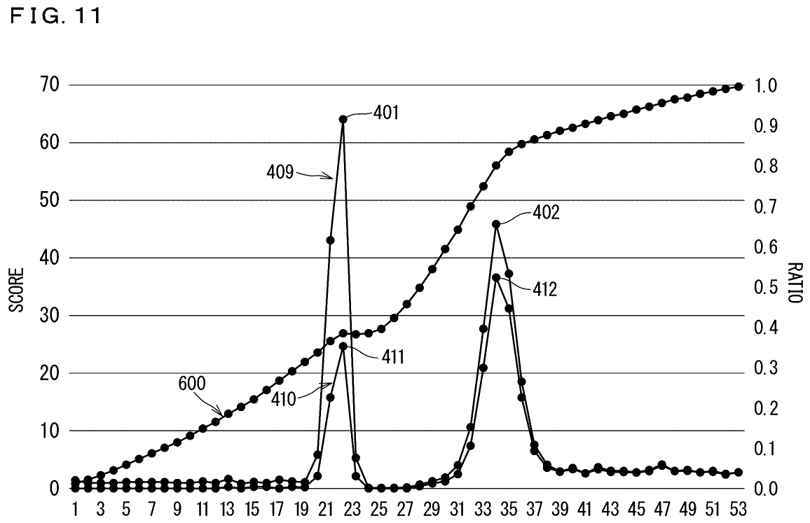

FIG. 11 is a diagram illustrating an example of distribution of the reference scores in the reference region 323 in the radial direction of the substrate W. In FIG. 11, the left vertical axis represents the magnitude of the score, and the horizontal axis represents the pixel position in the radial direction of the substrate W (the smaller the value, the more inner side in the radial direction).

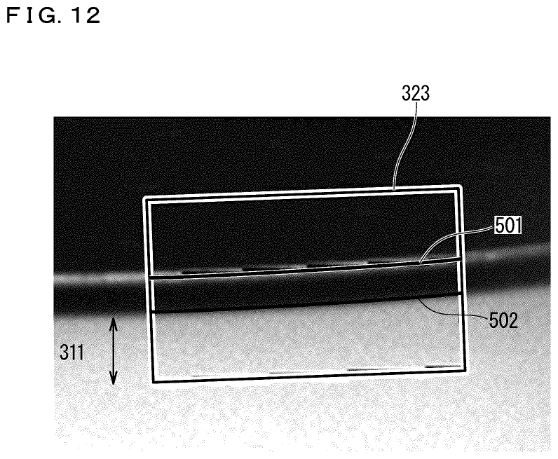

Further, FIG. 12 is a view illustrating an example of an image including the reference region 323. FIG. 12 illustrates the direction 311 in which the images of the reference region 323 are adjacent to each other.

A reference score 409 in FIG. 11 indicates the distribution of the value (score) obtained by adding together the luminance differences between the pixels adjacent to each other in the direction 311 in the reference region 323 (a pair of the target pixel and the pixel adjacent thereto) in the direction orthogonal to the direction 311. A peak 401 of the score of the reference score 409 in FIG. 11 corresponds to a pixel position 501 in FIG. 12. In addition, a peak 402 of the score of the reference score 409 in FIG. 11 corresponds to a pixel position 502 in FIG. 12.

In FIG. 12, an image with low luminance seen between the pixel position 501 and the pixel position 502 in the reference region 323 is an image corresponding to a shadow of the substrate W. The shadow of the substrate W is inevitably displayed in the image depending on the imaging direction of the camera 70, but in some cases, it is difficult to clearly identify the end portion of the substrate W in the image in which the shadow of the substrate W is displayed. Therefore, as the end portion of the substrate W having high reproducibility, a region including the shadow of the substrate W can be set as the end portion of the substrate W.

Therefore, in order to accurately detect a boundary (that is, a boundary formed by the shadow of the substrate W) between the region with low luminance indicating the substrate W including the shadow and the region with high luminance other than the substrate W, the distribution coefficient based on the luminance distribution of the pixel in the reference region 323 is multiplied by the value of the reference score 409. In FIG. 11, a distribution coefficient 600 of the pixel in the reference region 323 is illustrated in an overlapping manner. The distribution coefficient 600 is indicated by the ratio of the luminance level indicated on the right vertical axis. The distribution coefficient 600 normalizes the average luminance of pixels located on the radially outer side in the substrate W of the target pixel, and indicates the normalized average luminance as a ratio.

The value of the reference score 409 multiplied by the value of the distribution coefficient 600 is a corrected reference score 410. In the corrected reference score 410, a peak 412 corresponding to the pixel position 502 in FIG. 12 is a peak having a higher score than a peak 411 corresponding to the pixel position 501, and the pixel position 502 in the reference region 323 can be detected as the pixel position (reference pixel position) of the end portion of the substrate W.

Note that the distribution coefficient 600 is illustrated as a ratio to the average value of the luminance of the pixels in the reference region 323, but the distribution coefficient 600 only needs to reflect the distribution of the luminance in the reference region 323, and may be, for example, the average value of the luminance of the entire pixels located radially inner side of the target pixel, or may be replaced with a variance value or a standard deviation of the luminance distribution in the reference region 323.

Furthermore, the end portion not including the shadow of the substrate W may be set as the end portion of the substrate W. That is, in a case where the end portion of the substrate W can be clearly identified, the pixel position 501 in FIG. 12 may be detected as the pixel position (reference pixel position) of the end portion of the substrate W.

Furthermore, the reference pixel position described above corresponds to the position of one pixel having a score of the reference score (or corrected reference score) that is the highest, but in order to improve the accuracy of the reference pixel position, for example, an approximate curve can be generated by using the scores of the pixels on both sides (or further, the adjacent peripheral pixels thereof) of the pixel having the highest score, and the position of the vertex of the approximate curve can be set as the reference pixel position (spline interpolation). With such processing, the positional accuracy of the reference pixel position can be improved. The same applies to the comparison pixel position described later.

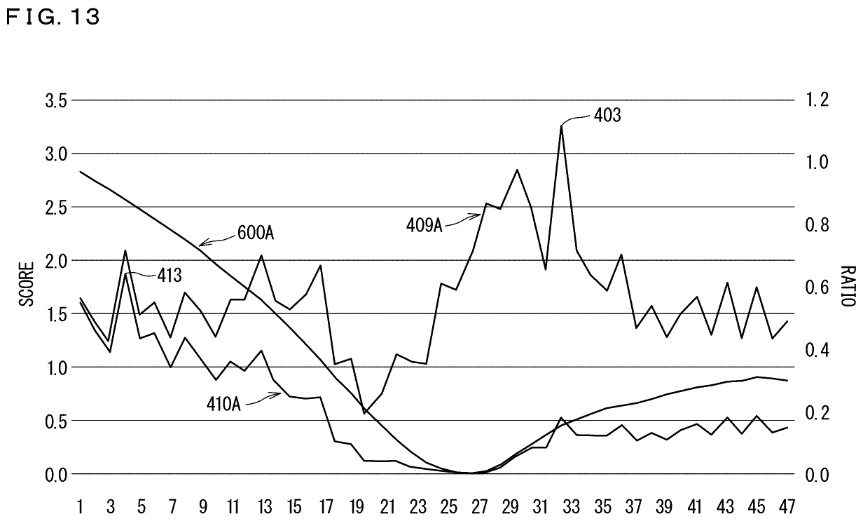

FIG. 13 is a diagram illustrating an example of distribution of the reference scores in the reference region 322 in the radial direction of the substrate W. In FIG. 13, the left vertical axis represents the magnitude of the score, and the horizontal axis represents the pixel position in the radial direction of the substrate W (the smaller the value, the more inner side in the radial direction).

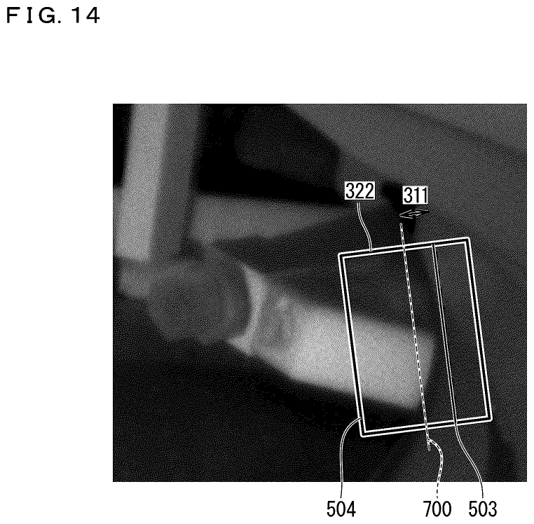

Further, FIG. 14 is a view illustrating an example of an image including the reference region 322. FIG. 14 illustrates the direction 311 in which the images of the reference region 322 are adjacent to each other.

A reference score 409A in FIG. 13 indicates the distribution of the value (score) obtained by adding together the luminance differences between the pixels adjacent to each other in the direction 311 in the reference region 322 in the direction orthogonal to the direction 311. A peak 403 of the score of the reference score 409A in FIG. 13 corresponds to a pixel position 503 in FIG. 14.

Here, similarly to the case of FIG. 11, the distribution coefficient based on the luminance distribution of the pixel in the reference region 322 is multiplied by the value of the reference score 409 A. In FIG. 13, a distribution coefficient 600A of the pixel in the reference region 322 is illustrated in an overlapping manner. The distribution coefficient 600A is indicated by the ratio of the luminance level indicated on the right vertical axis.

The value of the reference score 409A multiplied by the value of the distribution coefficient 600A is a corrected reference score 410A. In the corrected reference score 410A, a peak 413 corresponding to a pixel position 504 in FIG. 14 has the highest score. The pixel position 504 corresponds to a position on the radially inner side of the reference region 322, and is not appropriate as the pixel position of the end portion of the substrate W.

It is considered that the above problem occurs because the luminance is high in the region where the substrate W is shown. As illustrated in FIG. 14 as an example, in a case where an image of another structure is reflected on the surface of the substrate W to cause the luminance to increase, for example, when it is attempted to detect the pixel position of the end portion of the substrate W by using the corrected reference score 410A calculated by multiplying the distribution coefficient 600A, the high luminance in the region where the substrate W is indicated increases the corrected reference score in the region, and the detection of the pixel position of the end portion of the substrate W is hindered.

Therefore, it is set that the end portion of the substrate W can be detected as the reference pixel position by using the corrected reference score only in a case where the luminance on the radially inner side of the substrate W with respect to the reference region is lower than the luminance on the radially outer side of the substrate W. In this way, even in a case where an unintended luminance change occurs in the image showing the substrate W having a relatively low luminance, the reference pixel position can be prevented from being detected on the basis of the change.

For example, while a boundary line 700 illustrated in FIG. 14 is defined as a line that divides the reference region 322 in half in the radial direction of the substrate W, the average luminance of the pixels on the radially inner side of the substrate W with respect to the boundary line 700 is compared with the average luminance of the pixels on the radially outer side of the substrate W with respect to the boundary line 700, and only in a case where the average luminance of the pixels on the radially inner side of the substrate W is low (in a case where the average luminance of the pixels on the radially outer side of the substrate W is high), the end portion of the substrate W is detected as the reference pixel position by using the corrected reference score.

Note that the boundary line 700 for comparing the average luminance is not limited to the line that divides the reference region 322 in half, but in view of the fact that the reference region is set such that the pixel position corresponding to the end portion of the substrate W is in the vicinity of the center in the reference region, the region with low average luminance (for example, a region in which the substrate W is shown) and the region with high average luminance (for example, a peripheral region surrounding the substrate W) can be easily divided by using the boundary line 700 as the line that divides the reference region in half. Therefore, it becomes easy to determine whether the luminance on the radially inner side of the substrate W in the reference region is higher or lower than the luminance on the radially outer side of the substrate W.

### <Setting of Comparison Region>

The setting of the comparison region is performed similarly to the setting of the reference region. Specifically, the imaging of the substrate W held by the spin chuck 20 is performed by the camera 70 or another imaging apparatus, and the analysis unit 91 in the control unit 9 sets, as the comparison region, a region in a range similar to that in a case where the reference region is set in the obtained image. Here, it is unclear whether or not the substrate W in the image in which the comparison region is set is appropriately held by the spin chuck 20, unlike the substrate W in the image in which the reference region is set. In the image in which the comparison region is set, that is, the comparison image (the image to be compared with the reference image) which is the image indicating the state in which the non-rotating substrate W is held by the spin chuck 20, it is assumed that the substrate W to be subjected to the substrate processing is shown.

Next, the analysis unit 91 in the control unit 9 calculates the luminance of each pixel in the comparison region, and further calculates a difference (luminance difference) in luminance between each pixel and an adjacent pixel. Here, the direction in which the pixels are adjacent to each other is a direction along the radial direction of the substrate W.

Then, the analysis unit 91 in the control unit 9 adds together the luminance differences calculated as described above for the respective pixels in the direction orthogonal to the radial direction of the substrate W. The value of the luminance differences thus added together in the comparison region is set as a comparison score.

### <Detection of Comparison Pixel Position>

Next, the analysis unit 91 in the control unit 9 compares the comparison scores each calculated as described above in the radial direction of the substrate W.

Then, a pixel position corresponding to a peak having the highest score of the comparison score is detected as the comparison pixel position. Here, the comparison pixel position can be detected by using a corrected comparison score in a case where the luminance on the radially inner side of the substrate W in the comparison region is lower than the luminance on the radially outer side of the substrate W. In this way, even in a case where an unintended luminance change occurs in the image showing the substrate W having a relatively low luminance, the comparison pixel position can be prevented from being detected on the basis of the change.

Here, the corrected comparison score is obtained by multiplying the value of the comparison score by the value of the distribution coefficient based on the luminance distribution of the pixel in the comparison region.

### <Determination of Holding Position>

Next, in a case where the difference (difference in pixel positions) between the reference pixel position and the corresponding comparison pixel position thereto does not exceed a predetermined threshold, the analysis unit 91 of the control unit 9 determines that the substrate W is appropriately held in the spin chuck 20. Here, the reference pixel position and the corresponding comparison pixel position corresponding thereto refer to a reference pixel position detected in the reference region and a comparison pixel position detected in the comparison region in a case where the reference region and the comparison region corresponding thereto are respectively specified.

At this time, the direction of the positional deviation of the entire substrate W can be detected by referring also to the result of the positional deviation in the comparison region positioned diagonally to the substrate W.

For example, in a case where the positional deviation in the comparison region corresponding to the reference region 320 is radially inward in the substrate W and the positional deviation in the comparison region corresponding to the reference region 322 is radially outward in the substrate W, it can be seen that, as a whole, the substrate W is shifted and held on the side where the reference region 322 is set. Similarly, in a case where the positional deviation in the comparison region corresponding to the reference region 321 is radially inward in the substrate W and the positional deviation in the comparison region corresponding to the reference region 323 is radially outward in the substrate W, it can be seen that, as a whole, the substrate W is shifted and held on the side where the reference region 323 is set.

### Second Embodiment

A position determination apparatus and a position determination method of determining the position of the substrate to be processed in the substrate processing apparatus related to the present embodiment will be described. Note that, in the following description, constituent elements similar to the constituent elements described in the embodiment described above are denoted by the same reference numerals, and detailed description thereof will be omitted as appropriate.

### <Configuration of Substrate Processing Apparatus>

The configuration of the substrate processing apparatus is similar to the configuration illustrated in FIGS. 1 to 5.

### <Operation of Substrate Processing Apparatus>

In the present embodiment, in addition to the determination of the holding position of a substrate W, an analysis unit 91 performs matching processing by using the image of the chuck pin captured by a camera 70 and calculates matching coordinates. Then, the analysis unit 91 detects the open/closed state of a chuck pin 26 on the basis of the matching coordinates.

By operating the analysis unit 91 as described above, whether or not the substrate W is appropriately held can be determined while the open/closed state of the chuck pin 26 in a spin chuck 20 that holds the substrate W is considered. Therefore, the holding state of the substrate W can be accurately grasped.

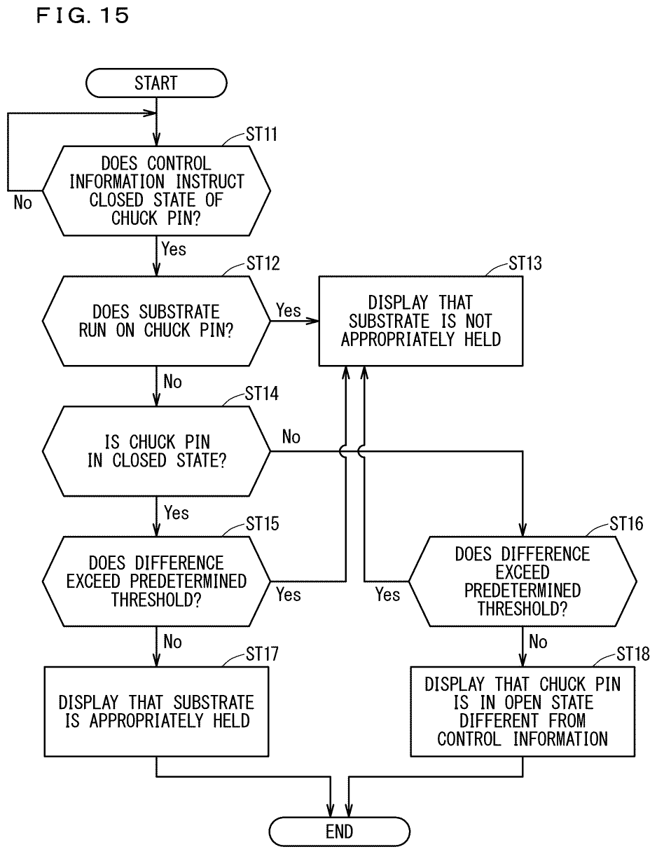

FIG. 15 is a flowchart illustrating an operation example of the substrate processing apparatus related to the present embodiment. The operation illustrated in FIG. 15 is performed by a control unit 9.

First, in step ST11, it is determined whether or not control information transmitted from a drive control unit 93 is the one that instructs the closed state of the chuck pin 26. Then, in a case where the control information is the one that instructs the closed state of the chuck pin 26, the process proceeds to step ST12. On the other hand, in a case where the control information is not the one that instructs the closed state of the chuck pin 26, step ST11 is performed again.

Next, in step ST12, the analysis unit 91 determines whether or not the substrate W runs on the chuck pin 26 on the basis of the matching coordinates described later. Then, in a case where the substrate W runs on the chuck pin 26, the process proceeds to step ST13. On the other hand, in a case where the substrate W does not run on the chuck pin 26, the process proceeds to step ST14.

In step ST13, the drive control unit 93 determines that the substrate W is not appropriately held (that is, the substrate W is not disposed at an appropriate position by the chuck pins 26, any of the chuck pins cannot grip the substrate W, or the like), and issues a predetermined warning (alarm display, or prompting to redo the disposition of the substrate W, or the like).

Next, in step ST14, the analysis unit 91 determines whether or not the chuck pin 26 is in the closed state on the basis of the matching coordinates described later. Then, in a case where the chuck pin 26 is in the closed state, the process proceeds to step ST15. On the other hand, in a case where the chuck pin 26 is not in the closed state, the process proceeds to step ST16.

In step ST15, the analysis unit 91 determines the holding position of the substrate W described in the first embodiment, and determines whether or not the difference between the reference pixel position and the corresponding comparison pixel position exceeds a predetermined threshold. Then, in a case where the difference exceeds the threshold, the process proceeds to step ST13. On the other hand, in a case where the difference does not exceed the threshold, the process proceeds to step ST17, and predetermined display indicating that the substrate W is appropriately held is performed.

In step ST16, the analysis unit 91 determines the holding position of the substrate W described in the first embodiment, and determines whether or not the difference between the reference pixel position and the corresponding comparison pixel position exceeds a predetermined threshold. Then, in a case where the difference exceeds the threshold, the process proceeds to step ST13. On the other hand, in a case where the difference does not exceed the threshold, the process proceeds to step ST18, and predetermined display is performed, the display indicating that the substrate W is disposed and the chuck pin 26 is in the open state that is different from the control information.

### <Detection of Open/Closed State of Chuck Pin>

Among the above operations, detection (state detection) of the open/closed state of the chuck pin 26 performed by the control unit 9 will be described.

Although the drive of the chuck pin 26 is controlled by the drive control unit 93 of the control unit 9, the chuck pin 26 does not operate as intended in the drive control unit 93 in some cases (as in the control information transmitted from the drive control unit 93) due to a defect of the chuck pin 26 itself, a defect of the substrate W gripped by the chuck pin 26 (for example, in a case where the position where the substrate W is disposed is deviated from a predetermined position), or the like. Therefore, by detecting the open/closed state of the chuck pin 26, whether or not the chuck pin 26 is operating as instructed by the drive control unit 93 can be confirmed. Furthermore, the arrangement of the substrate W can be corrected or the control signal can be output again from the drive control unit 93 in accordance with the confirmation result.

In the present embodiment, the matching coordinates are calculated by preparing a plurality of images indicating the chuck pin 26 and performing the matching processing (specifically, pattern matching processing) between the images. Here, the matching coordinates are coordinates indicating a relative positional relationship between images in a case where the matching score between the images is the highest.

In the present embodiment, first, three types of reference images are prepared in accordance with the open/closed state of the chuck pin 26. Specifically, images showing the chuck pin 26 in a state where the chuck pin 26 does not grip the substrate W and is completely closed (first state), a state where the chuck pin 26 is gripping the substrate W (second state), and a state where the chuck pin 26 is open (third state) are prepared as reference images.

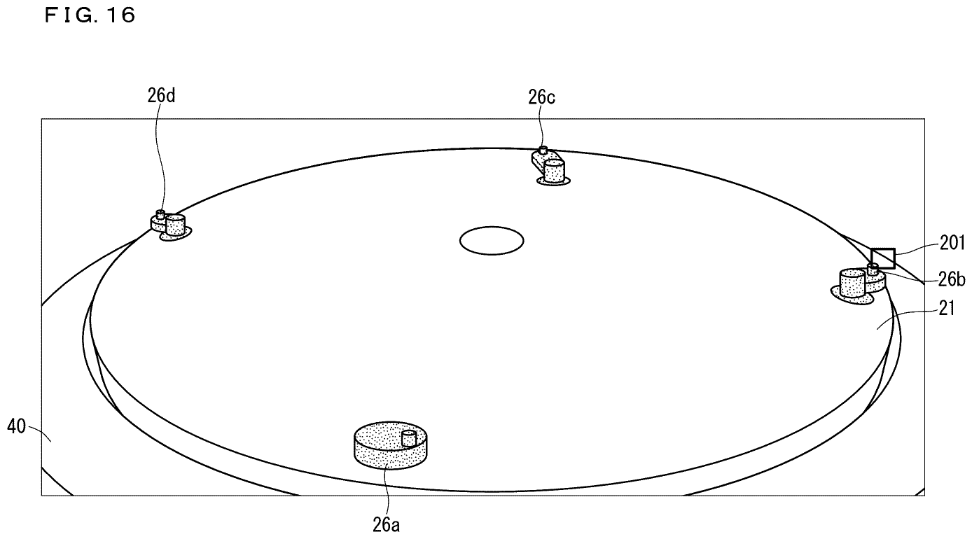

FIG. 16 is a diagram illustrating an example of an entire image of the whole of a spin chuck 20 for obtaining the reference image in the first state. As illustrated in FIG. 16, an image captured by the camera 70 or the like includes a plurality of the chuck pins 26 (the respective chuck pins are also referred to as a chuck pin 26a, a chuck pin 26b, a chuck pin 26c, and a chuck pin 26d).

A reference image 201 for detecting the open/closed state of the chuck pin 26 is extracted from the image as described above. Specifically, for at least one of the plurality of chuck pins 26, a range including at least a part of the chuck pin 26 (for example, an upper end portion of the chuck pin 26 that is displaced in accordance with opening and closing of the chuck pin 26, or the like) is set as the reference image 201.

Note that, in the present embodiment, three types of the reference images 201 are prepared for each of the plurality of chuck pins 26 in accordance with the above-described open/closed state, but at least one type of reference image 201 may be prepared for at least one chuck pin 26.

In addition, the reference image 201 may be extracted from an image obtained by actually imaging the chuck pin 26 by the camera 70, or may be extracted from an image obtained by another method.

Furthermore, an image for obtaining the reference image 201 in the second state is not limited to the case where the chuck pin 26 is actually holding the substrate W, and may be realized by invalidating a magnet or a spring enabling the holding of the chuck pin 26 and showing the chuck pin 26 in which the degree of opening and closing similar to the state of holding the substrate W is maintained in the image.

In addition, the range of the reference image 201 in the second state does not preferably include the substrate W. By having a portion other than the chuck pin 26 not included in the range of the reference image 201, accuracy is improved by matching described later.

Next, an image of the spin chuck 20 including the chuck pin 26 is captured by using the camera 70. Then, a target image that is an image for performing the pattern matching processing with the reference image is prepared.

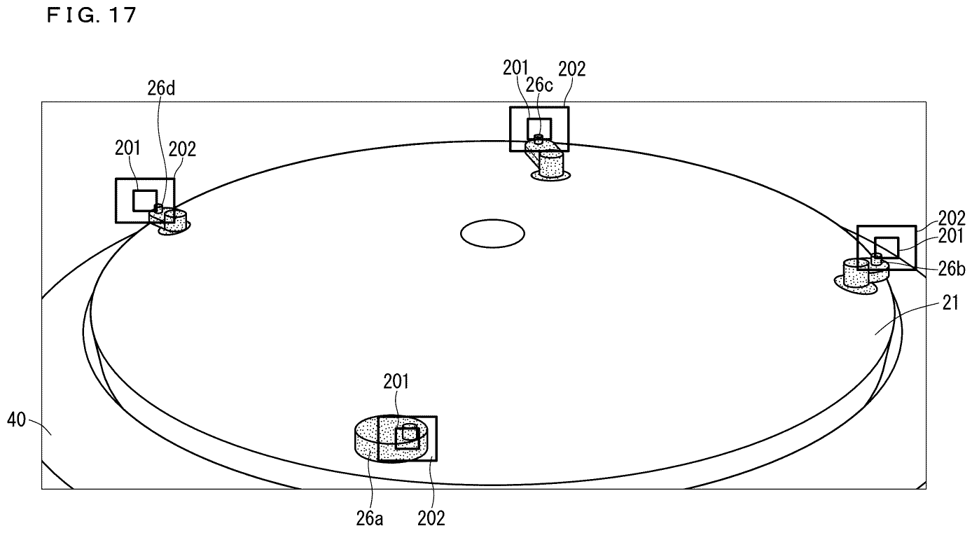

FIG. 17 is a diagram illustrating the spin chuck 20, for obtaining the target image. As illustrated in FIG. 17, the entire image captured by the camera 70 or the like includes the plurality of chuck pins 26.

A target image 202 for performing the pattern matching processing with the reference image 201 is extracted from the image described above. Specifically, for at least one of the plurality of chuck pins 26, a range including at least a part of the chuck pin 26 is set as the target image 202.

Here, the range of the reference image 201 can correspond to a partial range in the target image 202. That is, the range of the target image 202 can be set to be wider than the range of the reference image 201. By setting the range of the target image 202 in this manner, the pattern matching processing is performed by sequentially shifting the reference image 201 within the range of the target image 202, and the matching coordinates calculated in a case where the matching score is the highest can be searched for.

Specifically, first, the coordinates of a predetermined pixel in the reference image 201 in the first state of the chuck pin 26 are set as reference coordinates (X_{basis_pos1}, Y_{basis_pos1}), similarly, the coordinates of a predetermined pixel in the reference image 201 in the second state of the chuck pin 26 are set as reference coordinates (X_{basis_pos2}, Y_{basis_pos2}), and the coordinates of a predetermined pixel in the reference image 201 in the third state of the chuck pin 26 are set as reference coordinates (X_{basis_pos3}, Y_{basis_pos3}). FIG. 21 is a diagram illustrating an example of the reference coordinates in the reference image 201. As an example is illustrated in FIG. 21, the reference coordinates can be set as the lower left end portion (an origin Z) of the corresponding reference image. Note that the reference coordinates may be an optional position (for example, the upper right end portion of the reference image, the center of the reference image, or the like) in the reference image.

The reference image 201 is shown in the coordinate system of the entire image of the chuck pin 26 together with the target image 202, and is located in the coordinate system of the target image 202.

Next, the control unit 9 determines that the open/closed state of the chuck pin 26 at the present time is recognized as the first state, and performs the pattern matching between the target image 202 and the reference image 201. Then, the coordinates of the origin Z of the reference image 201 in a case where the matching score is the highest is searched. For example, in a case where the sum of squared difference (SSD) which is one of the methods for indicating similarity between images is used, the case where the matching score is the highest corresponds to a minimum value of an R_{SSD} value which is a sum of squares of differences of pixel values indicating similarity. Note that examples of the method of indicating similarity between images in the pattern matching include the sum of absolute difference (SAD) and the normalized cross-correlation (NCC), but are not limited thereto.

Here, in a case where the highest matching score is within a predetermined threshold (for example, the minimum value of the R_{SSD} value is smaller than the threshold), the coordinates of the origin Z of the reference image 201 in a case where the matching score is the highest is calculated as matching coordinates (X_{target}, Y_{target}). The matching coordinates are calculated in the coordinate system of the target image 202.

On the other hand, in a case where the highest matching score is not within the predetermined threshold (for example, the minimum value of the R_{SSD} value is greater than the threshold), the matching is regarded as a failure and the matching coordinates are not calculated. As a result, because the open/closed state of the chuck pin 26 can be detected on the basis of the matching coordinates in a case where the matching score is high, the detection accuracy of the open/closed state of the chuck pin 26 is improved. Note that the matching coordinates may be calculated regardless of whether or not the matching score is within the threshold.

Next, the analysis unit 91 detects the open/closed state of the chuck pin 26 on the basis of the matching coordinates. Specifically, if the similarity between the reference coordinates (X_{basis_pos1}, Y_{basis_pos1}) in the first state and the matching coordinates (X_{target}, Y_{target}) obtained as described above is within the predetermined threshold, it is considered that the recognition by the control unit 9 that the chuck pin 26 is in the first state is correct (that is, it is detected that the open/closed state of the chuck pin 26 is the first state). The similarity here is used, for example, to calculate a Euclidean distance between two coordinates and determine whether or not the value is within the above threshold.

On the other hand, if the above similarity is not within the predetermined threshold, it is considered that the recognition by the control unit 9 that the chuck pin 26 is in the first state is erroneous, and next, the similarity between the reference coordinates (X_{basis_pos2}, Y_{basis_pos2}) in the second state and the above matching coordinates (X_{target}, Y_{target}) is calculated. Then, if the similarity between the reference coordinates (X_{basis_pos2}, Y_{basis_pos2}) in the second state and the matching coordinates is not within the predetermined threshold, the similarity between the reference coordinates (X_{basis_pos3}, Y_{basis_pos3}) in the third state and the matching coordinates (X_{target}, Y_{target}) is further calculated. By such a method, the open/closed state of the chuck pin 26 can be accurately detected.

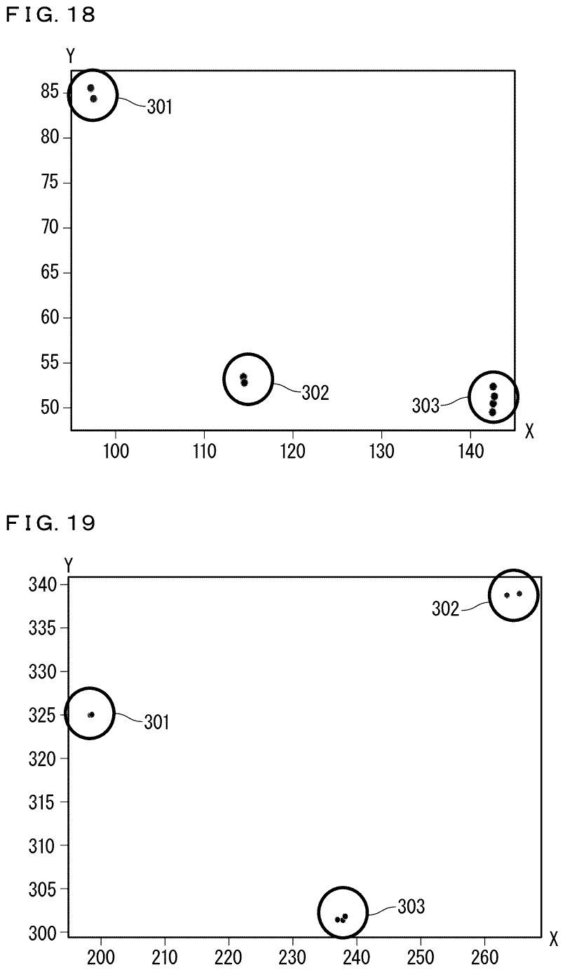

FIGS. 18 and 19 are diagrams each illustrating an example of a distribution of matching coordinates. FIG. 18 illustrates the distribution of matching coordinates of the chuck pin 26b in FIGS. 16 and 17. FIG. 19 illustrates the distribution of matching coordinates of the chuck pin 26d in FIGS. 16 and 17. In FIGS. 18 and 19, the vertical axis represents an example of the Y coordinate (numerical value is an example) of the coordinate system provided in the target image, and the horizontal axis represents an example of the X coordinate (numerical value is an example) of the coordinate system provided in the target image.

In FIGS. 18 and 19, the second states of the different chuck pins 26 are set as reference images, and the results of performing the pattern matching processing with a plurality of target images corresponding to the respective reference images are shown. In FIGS. 18 and 19, a range 301, a range 302, and a range 303 indicate predetermined ranges centered on the reference coordinates of the first state, the second state, and the third state, respectively. In the range 301, matching coordinates in a case where the chuck pin 26 in the target image 202 is an image indicating the first state are located (the range 301 corresponds to the threshold range in calculating the similarity in the first state). Further, in the range 302, matching coordinates in a case where the chuck pin 26 in the target image 202 is an image indicating the second state are located (the range 302 corresponds to the threshold range in calculating the similarity in the second state). Further, in the range 303, matching coordinates in a case where the chuck pin 26 in the target image 202 is an image indicating the third state are located (the range 303 corresponds to the threshold range in calculating the similarity in the third state).

As illustrated in FIGS. 18 and 19, the ranges where the matching coordinates are located are clearly separated from each other depending on the open/closed state (that is, the first state, the second state, and the third state) of the chuck pin 26 in the target image 202. That is, according to the matching coordinates, the open/closed state of the chuck pin 26 in the target image 202 can be clearly distinguished from each other (the same applies to the chuck pins other than the chuck pins 26b and 26d illustrated in FIGS. 18 and 19). Therefore, the analysis unit 91 can detect the open/closed state of the chuck pin 26 by determining which range the calculated matching coordinates belong to.

Here, in a case where the matching coordinates are not included in any of the range 301, the range 302, and the range 303, the analysis unit 91 does not detect the open/closed state of the chuck pin 26. As a result, because the open/closed state of the chuck pin 26 can be detected on the basis of the matching coordinates included in an appropriate range, the detection accuracy of the open/closed state of the chuck pin 26 is improved. Note that, in a case where the chuck pin 26 is not in any of the first state, the second state, and the third state, that is, in a case where the substrate W runs on the chuck pin 26 (corresponding to step ST12), in a case where the chuck pin 26 cannot hold the substrate W and is in an empty holding state although the substrate W is disposed, or the like, the matching coordinates are located at coordinates not included in any of the range 301, the range 302, and the range 303.

In the above example, the second state of the chuck pin 26 is used as the reference image. However, even in a case where another state (that is, the first state or the third state) is used as the reference image, the ranges where the matching coordinates are located are clearly separated from each other according to the open/closed state (that is, the first state, the second state, and the third state) of the chuck pin 26 in the target image 202. Therefore, similarly to the above example, the open/closed state of the chuck pin 26 in the target image 202 can be detected in accordance with the matching coordinates.

Furthermore, the size or position of the range 301, the range 302, and the range 303 including the matching coordinates may be changed depending on the average value of the calculated matching coordinates. However, in a case where the change in the size or position of the range exceeds the predetermined threshold range, there is a possibility that the chuck pin 26 is not appropriately driven due to aging or the like, and thus, a warning or the like may be output as necessary.

### <Detection of Presence or Absence of Substrate>

The range 301, the range 302, and the range 303 illustrated in FIGS. 18 and 19 correspond to the matching coordinates indicating the different open/closed states (the state in which the chuck pin 26 does not grip the substrate W and is completely closed, the state in which the chuck pin 26 is gripping the substrate W, and the state in which the chuck pin 26 is open regardless of the presence or absence of the substrate W) of the chuck pin 26. Among the above three open/closed states, in a case where the chuck pin 26 is gripping the substrate W, the state where the chuck pin 26 does not grip the substrate W and is completely closed is excluded, and in a case where the chuck pin 26 does not grip the substrate W, a state where the chuck pin 26 is gripping the substrate W is excluded. Therefore, a range in which the matching coordinates can be included is limited depending on whether or not the chuck pin 26 is gripping the substrate W.

Therefore, for example, by the analysis unit 91 performing image analysis (for example, luminance analysis at a position corresponding to the center portion of a spin base 21) on the image showing the spin chuck 20 as illustrated in FIG. 17, and detecting whether or not the chuck pin 26 is gripping the substrate W, not only the case where the matching coordinates are limited to any one of the range 301, the range 302, and the range 303, but also the open/closed state of the chuck pin 26 can be detected within a limited range (within the coordinate range) in accordance with whether or not the chuck pin 26 is gripping the substrate W. As a result, because the detection of the open/closed state of the chuck pin 26 can be suppressed on the basis of the matching coordinates not included in an appropriate range, the detection accuracy of the open/closed state of the chuck pin 26 is improved.

### <Extraction Range of Target Image>

When a structure (for example, a water droplet attached to the substrate W or the periphery of the spin chuck 20, or the like) other than the chuck pins 26 is included in the range of the target image 202, the matching accuracy is deteriorated in some cases.

Therefore, at the time of extracting the target image 202, by setting an extraction range to include the longitudinal direction along an outer edge portion 400 of the substrate W, it is possible to prevent structures other than the chuck pins 26 from being included in the image (at least to reduce a range in which structures other than the chuck pins 26 are included in the image) and to suppress mismatching.

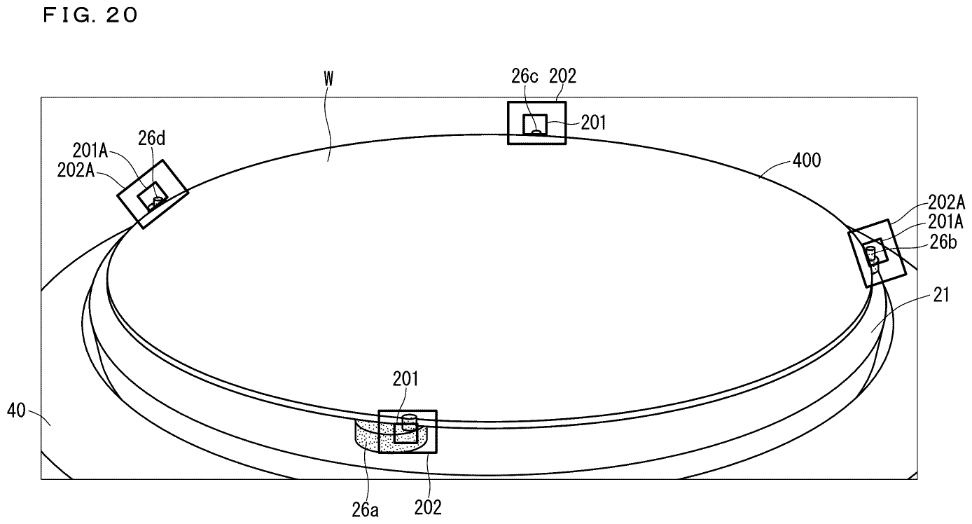

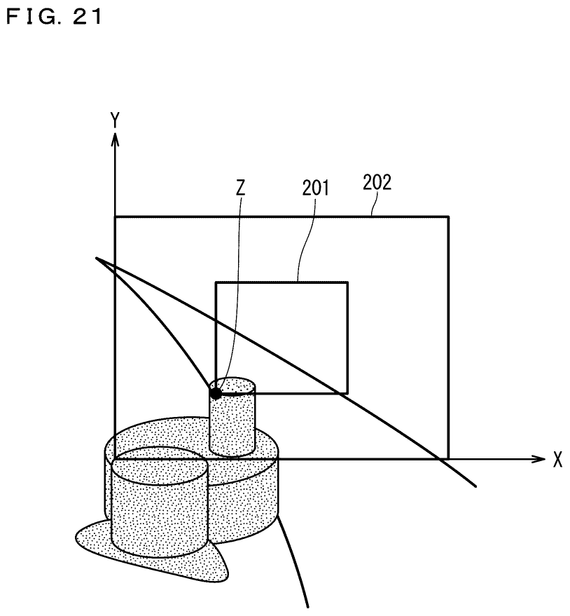

FIG. 20 is a diagram illustrating an example of extraction of the target image. As illustrated in FIG. 20 as an example, the extraction range of a target image 202A is set to include the longitudinal direction along the outer edge portion 400 of the substrate W. Therefore, the structures other than the chuck pin 26 is avoided from being included in the target image 202A.

Note that, although the extraction range of the target image 202 has been described above, the extraction range of a reference image 201A can also have the longitudinal direction along the outer edge portion 400 of the substrate W.

### Effects Produced by Plurality of Embodiments Described Above

Next, an example of effects generated by the plurality of embodiments described above will be described. Note that, in the following description, the effects will be described on the basis of the specific configurations exemplified in the plurality of embodiments described above, but may be replaced with other specific configurations exemplified in the present description in a range where similar effects are produced. That is, in the following description, there is a case where only one of the associated specific configurations is described as a representative for convenience, but the specific configuration described as the representative may be replaced with another specific configuration associated therewith.

Furthermore, the replacement may be performed across the plurality of embodiments. That is, the same effect may be produced by combining the respective configurations exemplified in the different embodiments.

According to the embodiment described above, in the position determination method, the substrate W that is held at the reference position of the substrate holding unit (spin chuck 20) and is in the non-rotating state is imaged, and the captured image is output as the reference image. Then, a region including the end portion of the substrate W in the reference image is set as the reference region 320 (alternatively, the reference region 321, the reference region 322, and the reference region 323), and the pixel position of the end portion of the substrate W in the reference region is detected as the reference pixel position. On the other hand, the substrate W that is disposed on the spin chuck 20 and is in the non-rotating state is imaged, and the captured image is output as the comparison image. Then, a region including the end portion of the substrate W in the comparison image is set as the comparison region, and the pixel position of the end portion of the substrate W in the comparison region is detected as the comparison pixel position. Then, it is determined whether or not the difference between the reference pixel position and the comparison pixel position exceeds a predetermined threshold. Here, the step of detecting the reference pixel position includes a step of calculating the reference score that is a value obtained by integrating a difference between the luminance of the target pixel that is a pixel to be a target in the reference region and the luminance of the adjacent pixel that is a pixel adjacent to the target pixel in the radial direction of the substrate W, between pixels aligned with the target pixel in a direction orthogonal to the radial direction, and a step of setting, as the reference pixel position, a position of the target pixel corresponding to the highest reference score among the plurality of reference scores sequentially calculated in the radial direction in the reference region. Furthermore, the step of detecting the comparison pixel position includes a step of calculating the comparison score that is a value obtained by integrating a difference between the luminance of the target pixel that is a pixel to be a target in the comparison region and the luminance of the adjacent pixel that is a pixel adjacent to the target pixel in the radial direction of the substrate W, between pixels aligned with the target pixel in a direction orthogonal to the radial direction, and a step of setting, as the comparison pixel position, a position of the target pixel corresponding to the highest comparison score among the plurality of comparison scores sequentially calculated in the radial direction in the comparison region.

According to such a configuration, the score is calculated by integrating the luminance differences in the direction orthogonal to the radial direction of the substrate W, and the reference pixel position and the comparison pixel position can be detected with high accuracy by using the score. Therefore, the positional deviation of the end portion of the substrate W can be determined with high accuracy on the basis of the difference between the reference pixel position and the comparison pixel position.

Note that, in a case where there is no particular limitation, the order in which the respective pieces of processing are performed can be changed.

Note that, even in a case where another configuration exemplified in the present description is appropriately added to the above configuration, that is, even in a case where another configuration not mentioned as the above configuration in the present description is appropriately added, a similar effect can be generated.

Furthermore, according to the embodiment described above, the difference between the luminance of the target pixel and the luminance of the adjacent pixel is calculated only in a case where the luminance of the target pixel or the adjacent pixel located on the radially outer side of the substrate W is higher. With such configuration, it is easy to distinguish between the image indicating the substrate W having the relatively low luminance and the image indicating the peripheral portion surrounding the substrate W having the relatively high luminance.

Further, according to the embodiment described above, a value obtained by multiplying the reference score by the distribution coefficient based on the luminance distribution in the reference region is set as the corrected reference score. Then, the reference pixel position is the position of the target pixel corresponding to the highest corrected reference score in the reference region. According to such a configuration, because the corrected reference score can be calculated by using the distribution coefficient reflecting the luminance distribution of the reference region, the detection accuracy of the reference pixel position can be improved.

Furthermore, according to the embodiment described above, only in a case where average luminance in the range on the inner side is lower than in the range on the outer side in the radial direction in the reference region, the reference pixel position is the position of the target pixel corresponding to the corrected reference score that is the highest in the reference region. According to such a configuration, even in a case where an unintended luminance change occurs in the image showing the substrate W having a relatively low luminance, the reference pixel position can be prevented from being detected on the basis of the change.

Further, according to the embodiment described above, a value obtained by multiplying the comparison score by the distribution coefficient based on the luminance distribution in the comparison region is set as the corrected comparison score. Then, the comparison pixel position is the position of the target pixel corresponding to the highest corrected comparison score in the comparison region. According to such a configuration, because the corrected comparison score can be calculated by using the distribution coefficient reflecting the luminance distribution of the comparison region, the detection accuracy of the comparison pixel position can be improved.

Furthermore, according to the embodiment described above, only in a case where average luminance in the range on the inner side is lower than in the range on the outer side in the radial direction in the comparison region, the comparison pixel position is the position of the target pixel corresponding to the corrected comparison score that is the highest in the comparison region. According to such a configuration, even in a case where an unintended luminance change occurs in the image showing the substrate W having a relatively low luminance, the comparison pixel position can be prevented from being detected on the basis of the change.

Furthermore, according to the embodiment described above, the distribution coefficient is the average luminance of the pixels located on the radially outer side of the target pixel. According to such a configuration, because the luminance distribution of the pixel in the reference region can be reflected in the reference score or the luminance distribution of the pixel in the comparison region can be reflected in the comparison score, the detection accuracy of the reference pixel position or the comparison pixel position can be improved.

Furthermore, according to the embodiment described above, the pixels in the reference region and the comparison region are mapped again to cause the pixels to be aligned along the radial direction. According to such a configuration, even in a case where the alignment direction of the pixels in the image does not match the radial direction of the substrate W, the luminance difference between the adjacent pixels and the sum thereof can be easily calculated by performing the mapping again and changing the alignment of the pixels.

According to the embodiment described above, the position determination apparatus includes the substrate holding unit that holds the substrate W, the imaging unit, and the analysis unit 91. Here, the substrate holding unit corresponds to, for example, the spin chuck 20. Furthermore, the imaging unit corresponds to, for example, the camera 70 or the like. The camera 70 images the substrate W in the spin chuck 20. The analysis unit 91 analyzes the image captured by the camera 70 and detects the pixel position of the end portion of the substrate W. Here, an image obtained by imaging, by the camera 70, the substrate W that is held at the reference position of the spin chuck 20 in the image and is in the non-rotating state is set as the reference image. Further, in the reference region 320 (alternatively, the reference region 321, the reference region 322, and the reference region 323) which is a region including the end portion of the substrate W in the reference image, the pixel position of the end portion of the substrate W is set as the reference pixel position. Furthermore, an image (image to be compared with the reference image) obtained by imaging, by the camera 70, the substrate W that is disposed on the spin chuck 20 and is in the non-rotating state is set as the comparison image. Further, in the comparison region which is a region including the end portion of the substrate W in the comparison image, the pixel position of the end portion of the substrate W is set as the comparison pixel position. Then, the analysis unit 91 detects the reference pixel position and the comparison pixel position, and determines whether or not a difference between the reference pixel position and the comparison pixel position exceeds a threshold. Here, the analysis unit 91 calculates the reference score that is a value obtained by integrating a difference between the luminance of the target pixel that is a pixel to be a target in the reference region and the luminance of an adjacent pixel that is a pixel adjacent to the target pixel in the radial direction of the substrate W, between pixels aligned with the target pixel in a direction orthogonal to the radial direction. Then, the analysis unit 91 detects, as the reference pixel position, the position of the target pixel corresponding to the highest reference score among the plurality of reference scores sequentially calculated in the radial direction in the reference region. Furthermore, the analysis unit 91 calculates the comparison score that is a value obtained by integrating a difference between the luminance of the target pixel that is a pixel to be a target in the comparison region and the luminance of an adjacent pixel that is a pixel adjacent to the target pixel in the radial direction of the substrate W, between pixels aligned with the target pixel in a direction orthogonal to the radial direction. Then, the analysis unit 91 detects, as the comparison pixel position, the position of the target pixel corresponding to the highest comparison score among the plurality of comparison scores sequentially calculated in the radial direction in the comparison region.

According to such a configuration, the score is calculated by integrating the luminance differences in the direction orthogonal to the radial direction of the substrate W, and the reference pixel position and the comparison pixel position can be detected with high accuracy by using the score. Therefore, the positional deviation of the end portion of the substrate W can be determined with high accuracy on the basis of the difference between the reference pixel position and the comparison pixel position.

In addition, even in a case where another configuration exemplified in the present description is appropriately added to the above configuration, that is, even in a case where another configuration not mentioned as the above configuration in the present description is appropriately added, a similar effect can be generated.

### Modifications of Plurality of Embodiments Described Above

In the plurality of embodiments described above, the luminance of the pixel is added together in order to calculate the reference score or the comparison score, but instead of the luminance of the pixel, for example, an average value of RGB elements in one pixel may be added together. Furthermore, the adjacent pixel that is a pixel adjacent to the target pixel is not limited to one pixel adjacent to the target pixel, and may further include one or two adjacent pixels.

In addition, in the plurality of embodiments described above, there are cases where properties and types of material, dimensions, shapes, relative arrangement relationships, implementation conditions, and the like of the respective constituent elements are also described, but these are one example in all aspects and are not restrictive.

Therefore, innumerable modifications and equivalents in which no examples are shown are assumed within the scope of the technology disclosed in the present description. For example, a case where at least one constituent element is modified, added, or omitted, and a case where at least one constituent element in at least one embodiment is extracted and combined with a constituent element in another embodiment are included.

Furthermore, in at least one embodiment described above, in a case where a material name or the like is described without being particularly specified, unless there is a contradiction, the material includes other additives, for example, an alloy or the like.

In addition, each constituent element described in the embodiments described above is assumed as software or firmware, or hardware corresponding thereto. As the software, for example, a “unit” or the like is referred to, and as the hardware, for example, a “processing circuit” (circuitry) or the like is referred to.

### EXPLANATION OF REFERENCE SIGNS

91: analysis unit
201: reference image
201A: reference image
304: reference region
320: reference region
321: reference region
322: reference region
323: reference region
409: reference score
409A: reference score
410: corrected reference score
410A: corrected reference score
501: pixel position
502: pixel position
503: pixel position
504: pixel position
600: distribution coefficient
600A: distribution coefficient

1. A position determination method comprising:
capturing an image of a substrate that is held at a reference position of a chuck and is in a non-rotating state, and outputting the image captured as a reference image;
setting a region including an end portion of said substrate in said reference image as a reference region, and detecting a pixel position of said end portion of said substrate in said reference region as a reference pixel position;
capturing an image of the substrate that is disposed in said chuck and is in a non-rotating state, and outputting the image captured as a comparison image;
setting a region including the end portion of said substrate in said comparison image as a comparison region, and detecting a pixel position of said end portion of said substrate in said comparison region as a comparison pixel position; and
determining whether or not a difference between said reference pixel position and said comparison pixel position exceeds a predetermined threshold,
wherein detecting said reference pixel position includes:
calculating a reference score that is a value obtained by integrating a difference between luminance of a target pixel that is a pixel to be a target in said reference region and luminance of an adjacent pixel that is a pixel adjacent to said target pixel in a radial direction of said substrate, between pixels aligned with said target pixel in a direction orthogonal to said radial direction; and
setting, as said reference pixel position, a position of said target pixel corresponding to said reference score that is highest among a plurality of said reference scores sequentially calculated in said radial direction in said reference region, and
detecting said comparison pixel position includes:
calculating a comparison score that is a value obtained by integrating a difference between luminance of a target pixel that is a pixel to be a target in said comparison region and luminance of an adjacent pixel that is a pixel adjacent to said target pixel in the radial direction of said substrate, between pixels aligned with said target pixel in a direction orthogonal to said radial direction; and
setting, as said comparison pixel position, a position of said target pixel corresponding to said comparison score that is highest among a plurality of said comparison scores sequentially calculated in said radial direction in said comparison region.

2. The position determination method according to claim 1, wherein the difference between the luminance of said target pixel and the luminance of said adjacent pixel is calculated only in a case where the luminance of one of said target pixel and said adjacent pixel located on an outer side in said radial direction of said substrate is higher than another of said target pixel and said adjacent pixel.

3. The position determination method according to claim 1, wherein
said reference score is multiplied by a distribution coefficient based on a luminance distribution in said reference region to obtain a value that is to be set as a corrected reference score, and
said reference pixel position is a position of said target pixel corresponding to said corrected reference score that is highest in said reference region.

4. The position determination method according to claim 3, wherein said reference pixel position is the position of said target pixel corresponding to said corrected reference score that is the highest in said reference region only in a case where average luminance in a range on an inner side is lower than in a range on an outer side in said radial direction in said reference region.

5. The position determination method according to claim 1, wherein
said comparison score is multiplied by a distribution coefficient based on a luminance distribution in said comparison region to obtain a value that is to be set as a corrected comparison score, and
said comparison pixel position is a position of said target pixel corresponding to said corrected comparison score that is highest in said comparison region.

6. The position determination method according to claim 5, wherein said comparison pixel position is the position of said target pixel corresponding to said corrected comparison score that is the highest in said comparison region only in a case where average luminance in a range on an inner side is lower than in a range on an outer side in said radial direction in said comparison region.

7. The position determination method according to claim 3, wherein said distribution coefficient is an average luminance of pixels located on an outer side in said radial direction than said target pixel.

8. The position determination method according to claim 1, wherein said pixels in said reference region and said comparison region are mapped again to cause said pixels to be aligned along said radial direction.

9. A position determination apparatus comprising:
a chuck that holds a substrate;
a camera that captures an image of said substrate in said chuck; and
a processing circuitry that analyzes the image captured by said camera and detects a pixel position of an end portion of said substrate,
wherein said camera captures and sets an image of the substrate as a reference image, the substrate being held at a reference position of said chuck in said image and being in a non-rotating state,
said reference image includes a reference region that is a region including an end portion of said substrate, the reference region having a pixel position of said end portion of said substrate set as a reference pixel position,
said camera captures and sets an image of the substrate as a comparison image, the substrate being disposed in said chuck and being in a non-rotating state,
said comparison image includes a comparison region that is a region including an end portion of said substrate, the comparison region having a pixel position of said end portion of said substrate set as a comparison pixel position,
said processing circuitry detects said reference pixel position and said comparison pixel position and determines whether or not a difference between said reference pixel position and said comparison pixel position exceeds a threshold, and
said processing circuitry is configured to:
calculate a reference score that is a value obtained by integrating a difference between luminance of a target pixel that is a pixel to be a target in said reference region and luminance of an adjacent pixel that is a pixel adjacent to said target pixel in a radial direction of said substrate, between pixels aligned with said target pixel in a direction orthogonal to said radial direction, and detects, as said reference pixel position, a position of said target pixel corresponding to said reference score that is highest among a plurality of said reference scores sequentially calculated in said radial direction in said reference region; and
calculate a comparison score that is a value obtained by integrating a difference between luminance of a target pixel that is a pixel to be a target in said comparison region and luminance of an adjacent pixel that is a pixel adjacent to said target pixel in the radial direction of said substrate, between pixels aligned with said target pixel in a direction orthogonal to said radial direction, and detects, as said comparison pixel position, a position of said target pixel corresponding to said comparison score that is highest among a plurality of said comparison scores sequentially calculated in said radial direction in said comparison region.
